(19) United States
(12) Patent Application Publication
(10) Pub. No.: US 2026/0361572 A1
(43) Pub. Date: Nov. 12, 2026

(54) METHODS FOR TRACKING REFERENCE SIGNAL (TRS) BASED TIME DOMAIN CHANNEL PROPERTY (TDCP) REPORTING

(71) Applicant: Telefonaktiebolaget LM Ericsson (publ), Stockholm (SE)

(72) Inventors: Siva MURUGANATHAN, Stittsville (CA); Per ERNSTRÖM, Stockholm (SE); Shiwei GAO, Nepean (CA); Fredrik ATHLEY, Kullavik (SE); Jianwei ZHANG, Solna (SE)

(21) Appl. No.: 19/101,685

(22) PCT Filed: Aug. 7, 2023
(86) PCT No.: PCT/IB2023/057969

§ 371 Date: Feb. 6, 2025

Related U.S. Application Data
(60) Provisional application No. 63/396,076, filed on Aug. 8, 2022.
(60) Provisional application No. 63/396,088, filed on Aug. 8, 2022.

(51) Int. Cl. H04L 25/02; H04B 7/0456; H04L 5/00

(52) U.S. Cl. CPC H04L 25/0224; H04B 7/0456; H04L 5/0048

(57) ABSTRACT

A method, system and apparatus for methods for tracking reference signal (TRS)-based time domain channel property (TDCP) reporting and for dynamic update of measurement parameters for correlation-based TDCP reporting are disclosed. According to one aspect, a method in a network node includes determining a set of delay values, each delay value of the set of delay values being a separation in time between reference signal symbols used to determine correlation values. The method also includes transmitting the set of delay values to the WD. The method further includes receiving from the WD a report that includes a set of correlation values, the set of correlation values determined by the WD, the correlation values corresponding to the set of delay values.

### TECHNICAL FIELD

The present disclosure relates to wireless communications, and in particular, to methods for tracking reference signal (TRS)-based time domain channel property (TDCP) reporting and for dynamically updating measurement parameters for correlation-based time domain channel property (TDCP) reporting.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### MU-MIMO

With multi-user multiple input multiple output (MU-MIMO), two or more users in the same cell are co-scheduled on the same time-frequency resource(s). That is, two or more independent data streams are transmitted to different WDs at the same time, and the spatial domain may typically be used to separate the respective streams. By transmitting several streams simultaneously, the capacity of the system may be increased. This, however, comes at the cost of reducing the signal to interference plus noise ratio (SINR) per stream, as the power must be shared between streams and the streams will cause interference to each-other.

### Channel State Information Reference Signals (CSI-RS)

For CSI measurement and feedback, CSI-RS are defined. A CSI-RS is transmitted on each antenna port and is used by a WD to measure downlink channel between each of the transmit antenna ports and each of the receive antenna ports. The transmit antenna ports are also referred to as CSI-RS ports. The supported number of antenna ports in NR are {1,2,4,8,12,16,24,32}. By measuring the received CSI-RS, a WD may estimate the channel that the CSI-RS is traversing, including the radio propagation channel and antenna gains. The CSI-RS for the above purpose is also referred to as Non-Zero Power (NZP) CSI-RS. CSI-RS may be configured to be transmitted in certain resource elements (REs) in a slot and certain slots. FIG. 1 shows an example of CSI-RS REs for 12 antenna ports, where 1 RE per resource block (RB) per port is shown.

In addition, an interference measurement resource (IMR) is also defined in NR for a WD to measure interference. An IMR resource contains 4 REs, either 4 adjacent REs in frequency in the same orthogonal frequency division multiplexed (OFDM) symbol or 2 by 2 adjacent REs in both time and frequency in a slot. By measuring both the channel based on NZP CSI-RS and the interference based on an IMR, a WD may estimate the effective channel and noise plus interference to determine the CSI, i.e., rank, precoding matrix, and the channel quality.

Furthermore, a WD in NR may be configured to measure interference based on one or multiple NZP CSI-RS resources.

### TRS

Due to oscillator imperfections, transmission and reception may not be synchronized in time and/or frequency, which may cause inter- and intra-symbol interference. In NR, a tracking reference signal (TRS) was introduced that may be used by the WD for synchronization.

In the NR 3GPP specifications, TRS may be configured when a CSI report setting is not configured or when the higher layer parameter ‘reportQuantity’ in the CSI-ReportConfig information element (IE), associated with all the report settings linked with the CSI-RS resource set containing the TRS(s) is set to ‘none’. This means that CSI reporting based on measurements on the TRS is not supported in NR.

TRS is configured via ‘trs-Info’ in the NZP-CSI-RS-ResourceSet IE of 3GPP Technical Standard (TS) 38.331, which is associated with a CSI-RS resource set, for which the WD may assume that the antenna port with the same port index of the configured NZP CSI-RS resources in the said resource set is the same. In 3GPP specifications, TRS is specified as a special kind of NZP CSI-RS where the corresponding NZP CSI-RS resource set containing the TRS(s) has a higher layer parameter ‘trs-info’ set to true.

TRS is not really a CSI-RS. Rather, TRS is a resource set including multiple periodic NZP CSI-RS. More specifically, a TRS has four one-port, density-3 CSI-RSs located within two consecutive slots. The CSI-RS within the TRS resource set, may be configured with a periodicity of 10, 20, 40, or 80 ms. Note that the exact set of REs used for the TRS CSI-RS may vary. There is always a four-symbol time-domain separation between the two CSI-RS within a slot. FIG. 2 shows an example of a TRS burst of 2 TRS symbols in 2 adjacent slots.

NR also supports aperiodic TRS.

For LTE, the cell-specific reference signal (CRS) serves a same purpose as the TRS. LTE CRS may be used for synchronization, but may also be used for CSI reporting, which is not supported for TRS in NR. However, compared to the LTE CRS, the TRS implies much less overhead, only having one antenna port and only being present in two slots every TRS period.

FIG. 3 illustrates an example diagram of configurability of TRS symbol positions and TRS burst periodicity.

### CSI Framework in NR

In NR, a WD may be configured with multiple CSI reporting settings and multiple CSI-RS resource settings. Each resource setting may contain multiple resource sets, and each resource set may contain up to 8 CSI-RS resources. For each CSI reporting setting, a WD feeds back a CSI report.

Each CSI reporting setting contains at least the following information:
A CSI-RS resource set for channel measurement;
An IMR resource set for interference measurement;
Optionally, a CSI-RS resource set for interference measurement;
Time-domain behavior, i.e., periodic, semi-persistent, or aperiodic reporting;
Frequency granularity, i.e., wideband or subband;
CSI parameters to be reported such as rank indicator (RI), precoder matrix indicator (PMI), channel quality indicator (CQI), and CSI-RS resource indicator (CRI) in case of multiple CSI-RS resources in a resource set;
Codebook types, i.e., Type I or II, and codebook subset restriction;
Measurement restriction; and/or
Subband size. One out of two possible subband sizes is indicated, the value range depends on the bandwidth of the bandwidth part (BWP). One CQI/PMI (if configured for subband reporting) is fed back per subband.
   Type 1 and type 2 codebooks in NR

A Type 1 codebook (CB) is typically used by a WD to report CSI for single user MIMO (SU-MIMO) scheduling in NR, whereas Type 2 CB is typically for more accurate CSI feedback for multi-user MIMO (MU-MIMO) scheduling.

For both type 1 and type 2 CBs, for each rank, a precoding matrix W is defined in the form of:

$$W = {W}_{1} {W}_{2}$$

$$where {W}_{1} = [ \begin{matrix}{d}_{1} & {d}_{2} & … & {d}_{L} & 0 & 0 & … & 0 \\ 0 & 0 & … & 0 & {d}_{1} & {d}_{2} & … & {d}_{L}\end{matrix} ]$$

is a 2Nx2L matrix and contains information of L selected discrete Fourier transform (DFT) beams {dᵢ, i=1, . . . , L}, where dᵢ is a Nx1 DFT vector and N is the number of CSI-RS ports per polarization; while W₂ is a 2L×v matrix and contains the co-phasing coefficients between the selected beams and also between antenna ports with two different polarizations, where v is the number of layers or rank. W₁ is the same for the whole CSI bandwidth while W₂ may be for the whole bandwidth or per subband.

In case of type 1 CB, the precoding vector for each MIMO layer is associated with a single DFT beam. While for type 2 CB, the precoding vector for each layer is a linear combination of multiple DFT beams.

### Enhanced Type 2 Codebook in NR

In NR 3GPP Technical Release 16 (3GPP Rel-16), type 2 CB is enhanced by applying a frequency domain (FD) DFT basis across all subbands to reduced CSI feedback overhead and/or improve CSI accuracy. Instead of reporting W₂ for each subband, linear combinations of DFT basis vectors are used to jointly represent W₂ across the whole CSI bandwidth. For each layer, a precoding matrix W across all subbands is in the form of:

$$W = {W}_{1} {\tilde{W}}_{2} {W}_{f}^{H}$$

where W_{f}=[f₁, . . . , f_{M}] is a matrix containing M selected DFT basis vectors {f₁, . . . , f_{M}}, \tilde{W}₂ is 2L×M matrix containing the coefficients for each selected DFT beam and each selected FD basis vector.

### QCL and TCI States

Several signals may be transmitted from different antenna ports of a same base station. These signals may have the same large-scale properties such as Doppler shift/spread, average delay spread, or average delay. These antenna ports are then said to be quasi co-located (QCL).

If the WD knows that two antenna ports are QCL with respect to a certain parameter (e.g., Doppler spread), the WD may estimate that parameter based on one of the antenna ports and apply that estimate for receiving signal on the other antenna port. Typically, the first antenna port is represented by a measurement reference signal such as TRS or synchronization signal block (SSB) (known as the source reference signal (RS)) and the second antenna port is a demodulation reference signal (DMRS) (known as the target RS).

For instance, if antenna ports A and B are QCL with respect to average delay, the WD may estimate the average delay from the signal received from antenna port A and assume that the signal received from antenna port B has the same average delay. This is useful for demodulation since the WD may know beforehand the properties of the channel, which for instance, helps the WD in selecting an appropriate channel estimation filter.

Information about what assumptions may be made regarding QCL is signaled to the WD from the network node. In NR, four types of QCL relations between a transmitted source RS and transmitted target RS were defined:
Type A: {Doppler shift, Doppler spread, average delay, delay spread};
Type B: {Doppler shift, Doppler spread};
Type C: {average delay, Doppler shift};
Type D: {Spatial Rx parameter}.

### Channel Correlation, Doppler Spectrum, and Jakes Model

The wireless channel h (t) between a gNB and a WD may change over time as the WD moves. This is typically because the signals received at the WD include many paths of radio waves reflected from objects (such as trees and buildings) surrounding the WD, where each path has a different angle of arrival (AOA) at the WD and thus a different Doppler frequency as the WD moves. When the AOAs of the paths are uniformly distributed over [−π, π] in the azimuth direction, it is well known that the Doppler power spectrum for the channel h(t) may be modeled using the Jakes model (i.e., in two dimensions) as follows:

$$S ( f ) = \{ \begin{matrix}\frac{1}{π \cdot {f}_{max}} . \frac{1}{\sqrt{1 - {( \frac{f}{{f}_{max}} )}^{2}}} & ( \vert f \vert \leq {f}_{max} ) \\ 0 & ( \vert f \vert > {f}_{max} )\end{matrix}$$

The autocorrelation of the channel is defined as Rₕₕ(τ)=E[h(t)h*(t+τ)]. The normalized autocorrelation Rₕₕ(τ)/Rₕₕ(0)=J₀(2π·τ·fₘₐₓ), which is the inverse Fourier transform of S(f), where J₀(·) is the zeroth order Bessel function of the first kind, E[·] denotes expectation. As is known, the zeroth order Bessel function of the first kind is monotonic only for when 2π·τ·fₘₐₓ<3.8317. Within that range and for a given τ, there is a one to one mapping between a correlation value and an fₘₐₓ.

### 3GPP Rel-18 Specification of TRS Based TDCP Reporting

In the RAN1 #109e meeting, the following was considered. The work scope of TRS-based TDCP reporting focuses on the following use cases for evaluation purposes:
Targeting medium and high WD speed, e.g., 10-120 km/h as well as high speed train (HST) speed;
Aiding the network node (gNB) to determine:
   CSI reporting configuration and CSI-RS resource configuration parameters; and
   Precoding scheme, using one of the CSI feedback based precoding schemes or an UL-SRS reciprocity based precoding scheme; and
Aiding network node CSI prediction.

Several use cases for the network node to know the TDCP (time domain channel properties) based on TRS measurements have been considered. One use case for TDCP reporting is to enable the network node to select a transmission scheme that is more robust to channel ageing when the channel varies fast. For instance, based on the TRS-based TDCP reported by the WD to the network node, the network node may need to decide whether the precoder for the WD should be based on CSI obtained from uplink measurements or from CSI feedback obtained from the WD. Another example is that the network node may need to decide whether the precoder to schedule the WD should be based on Type I CSI feedback obtained from the WD or Type II CSI feedback obtained from the WD.

FIGS. 4 and 5 show graphs of examples of mean user throughput for a particular scheme relative to the mean throughput for feedback-based SU-MIMO precoding (the baseline) for 16 ports (FIG. 4) and for 32 ports (FIG. 5). The throughput is calculated for a traffic load corresponding to 70% resource utilization for the baseline case at each WD speed. Results for both SU-MIMO and MU-MIMO are shown. The scenario is UMa with 500 m inter-site distance. The carrier frequency is 2 GHz and the subcarrier spacing is 15 kHz. The CSI periodicity is 20 ms for both feedback and reciprocity-based CSI. The results show that reciprocity-based precoding has better performance at 3 km/h for both SU-MIMO and MU-MIMO. However, at WD speeds around 10 km/h the feedback-based precoding has better performance. Hence, the feedback-based precoding is more robust to rapidly varying channels. A speed of 10 km/h corresponds to a channel coherence time which is longer than two slots.

FIGS. 6 and 7 show an example comparison of the performance of precoding based on Type I and Type II CSI, respectively, for 16 ports (FIG. 6) and for 32 ports (FIG. 7). The results show that Type II CSI gives better performance at 3 km/h but at WD speeds around 10 km/h and higher, type I gives better performance.

These results show that it may be beneficial to select a precoding scheme based on some parameter that is related to the WD speed. It should be noted that it is not the WD speed per se that is the fundamental parameter in this context. Rather, it is how fast the channel varies which depends on the WD speed but also on the angle between the WD velocity vector and the propagation paths seen from the WD. Therefore, selection of a precoding scheme based on some time domain channel property such as coherence time or autocorrelation is a more suitable parameter.

WD measurement and reporting of time domain correlation based on TRS samples across different time lags is an efficient way to report TDCP based on TRS.

In order to define the time domain correlation measurement across TRS samples, let Xₗ[n], n=0,1, . . . , N−1 be the received frequency domain TRS samples after matched filtering and after removing the reference signal sequence. Index I denotes the different OFDM symbols carrying the TRSs used for the correlation estimation. Note that the TRSs used for the correlation estimation may be located in the same or different slots. The starting point in time of the OFDM symbol l is given by tₗ (to be precise tₗ denotes the start of the non-CP part of the OFDM symbol). Index n denote TRS sample index (assumed to be proportional to subcarrier index).

Let Pₘ(u), m=1 . . . M, u=1,2 be the l-indices of M symbol pairs to use for the estimation of the correlation for a delay τ=t_{P}_{ₘ}₍₂₎−t_{P}_{ₘ}₍₁₎. It is assumed that the M symbol pairs are separated by the same distance in time.

In one example, a low-complexity estimate of the normalized time domain correlation for a delay τ is calculated in the frequency domain as:

$$ϕ ( τ ) = \frac{{\sum }_{m = 1}^{M} {\sum }_{n = 0}^{N - 1} {X}_{{P}_{m} ( 2 )} [ n ] \cdot {X}_{{P}_{m} ( 1 )}^{*} [ n ]}{\frac{1}{2} {\sum }_{m = 1}^{M} {\sum }_{n = 0}^{N - 1} ( {X}_{{P}_{m} ( 1 )} [ n ] \cdot {X}_{{P}_{m} ( 1 )}^{*} [ n ] + {X}_{{P}_{m} ( 2 )} [ n ] \cdot {X}_{{P}_{m} ( 2 )}^{*} [ n ] )} .$$

In another example, the inverse DFT is calculated for each OFDM symbol l:

Yₗ[k]=ifft(Xₗ[n]).

The estimate of the normalized correlation for time delay t is calculated as:

$${ϕ}^{Δ t} ( t , τ ) = \frac{{\sum }_{m = 1}^{M} {\sum }_{k ∈ Γ ( m )} {Y}_{{P}_{m} ( 2 )} [ k ] \cdot {X}_{{P}_{m} ( 1 )}^{*} [ k ]}{\frac{1}{2} {\sum }_{m = 1}^{M} {\sum }_{k ∈ Γ ( m )} ( {Y}_{{P}_{m} ( 1 )} [ k ] \cdot {Y}_{{P}_{m} ( 1 )}^{*} [ k ] + {Y}_{{P}_{m} ( 2 )} [ k ] \cdot {Y}_{{P}_{m} ( 2 )}^{*} [ k ] )} ,$$

where the sum over time samples is over sets Γ(m) defined to suppress noise, e.g., by using a noise threshold such as, e.g.:

$$k ∈ Γ ( m ) ⇔ \{ \begin{matrix}\frac{\vert {Y}_{{P}_{m} ( 1 )} [ k ] \vert}{{σ}_{{P}_{m} ( 1 )}} > threshold \\ \frac{\vert {Y}_{{P}_{m} ( 2 )} [ k ] \vert}{{σ}_{{P}_{m} ( 2 )}} > threshold\end{matrix}$$

where σ_{P}_{ₘ}₍ᵢ₎ are noise estimates.

Note that at low speeds the change in the channel is small and the change in correlation at different delays within a TRS burst is quite small (note that the TRS burst is defined as in FIG. 2). Within a TRS burst, correlation may be measured for delays of 4 symbols, 10 symbols, 14 symbols, and 18 symbols as shown in the example of FIG. 8.

As the change in correlation at different delays within a TRS burst is quite small for low velocities, intra TR burst measurements are not enough to distinguish between different velocities in the low velocity region. Based on the results in FIGS. 4 and 5, to enable the network node to select a transmission scheme that is more robust against channel aging, the network node needs to distinguish between rather low WD speeds. Therefore, in order to distinguish between such low speeds from a TDCP report, support for measuring and reporting correlation for time delays corresponding to multiple TRS bursts is needed.

As discussed above, correlation value changes slowly over different delays within a TRS burst at low speeds. At higher speeds, the correlation values change more rapidly over different delays within a TRS burst. At high speeds, correlation measurements for small delays are needed in order to avoid ambiguities caused by aliasing. When inter TRS burst is considered, the correlation value may change more rapidly over different delays across different TRS bursts even for low speeds. Hence, with what granularity the correlation values should be reported as part of TRS based TDCP reporting is an open problem. Also, measuring of correlations on multiple time delays between TRS symbols transmitted at different time instances should be considered. One issue is that measurement of correlations on a large number of time delays between TRSs transmitted at different times will increase the WD's measurement complexity. For instance, the WD may need to measure correlation for multiple delays (e.g., 4 symbols, 10 symbols, 14 symbols, and 18 symbols within a TRS burst, and 5 slots, 10 slots, 20 slots, and 40 slots between TRS bursts) between TRS symbols transmitted at different time instances. However, this may increase measurement and correlation computation complexity at the WD. Therefore, how to reduce the measurement and computational complexity at the WD for measuring and computing correlation corresponding to multiple delays between TRSs is an open problem to solve.

### SUMMARY

Some embodiments advantageously provide methods, systems, and apparatuses for methods for tracking reference signal (TRS)-based time domain channel property (TDCP) reporting and for dynamically updating measurement parameters for correlation-based time domain channel property (TDCP) reporting.

Some embodiments dynamically update the delay values for TDCP reporting based on correlation values measured on a TRS.

Some embodiments update the configuration, triggering, and/or transmission of reference signals (e.g., TRSs) used for correlation measurements.

Some embodiments reduce the reporting overhead for correlation based TDCP measured on TRS. Methods proposed include the following:
method of using a correlation threshold to decide which of the correlation values to report;
method of absolute and differential reporting of correlation values;
details of signaling/configuration of correlation threshold and correlation value reporting;
In some embodiments, the network node is enabled to distinguish between different WD velocities and enables the network to select a precoding scheme based on the reported TDCP based on TRS.

In some embodiments, a method of measurement and reporting of TDCP may include one or more of the following:
WD receiving configuration from network node to measure and report:
correlation values corresponding to a first set of delay values;
WD measuring correlation values on the first set of delay values;
WD reporting correlation values corresponding to the first set of delay values or a subset of the delay values in the first set to the network node;
WD receiving signaling from network node to update the delay values in the first set; and/or
WD measuring correlation values on the updated set of delay values, and reporting all or a subset of the correlation values to the network node.

In addition, embodiments for updating the configuration, triggering, and/or transmission of reference signals (e.g., TRSs) used for correlation measurements are disclosed.

In some embodiments, a network node updates the delay values for which correlation between different TRS symbols (e.g., within a TRS burst or between different TRS bursts) may be measured by the WD. Hence, the WD does not have to measure correlation for a large number of delays. As a result, the solutions disclosed herein allow the measurement and computational complexity to be reduced at the WD.

According to one aspect, a network node configured to communicate with a wireless device, WD, is provided. The network node is configured to: determine a set of delay values, each delay value of the set of delay values being a separation in time between reference signal symbols used to determine correlation values; transmit the set of delay values to the WD; and receive from the WD a report that includes a set of correlation values, the set of correlation values determined by the WD, the correlation values corresponding to the set of delay values.

According to this aspect, in some embodiments, the set of delay values is transmitted via Radio Resource Control, RRC, signaling. In some embodiments, the reference signal symbols are tracking reference signal, TRS, symbols. In some embodiments, a subset of the set of delay values is associated with a periodicity of a TRS burst. In some embodiments, the network node is configured to receive a number of correlations the WD is configured to perform. In some embodiments, the set of correlation values are quantized correlation values. In some embodiments, the set of correlation values are absolute correlation values. In some embodiments, the set of correlation values are relative to a value of 1. In some embodiments, the set of correlation values are normalized correlation values. In some embodiments, the network node is configured to determine a velocity range of the WD based at least in part on the correlation values. In some embodiments, the network node is configured to deactivate reporting of correlation values that correspond to a subset of the set of delay values. In some embodiments, transmitting the set of delay values includes transmitting a bitmap indicating which of n autocorrelation values are to be reported by the WD. In some embodiments, transmitting the set of delay values includes transmitting positive integers a and b indicating a beginning time and ending time for the WD to determine correlation values. In some embodiments, transmitting the set of delay values includes transmitting a threshold to which the WD compares each correlation value to decide whether to include the correlation value in the report.

According to another aspect, a method in a network node configured to communicate with a wireless device, WD, is provided. The method includes: determining a set of delay values, each delay value of the set of delay values being a separation in time between reference signal symbols used to determine correlation values; transmitting the set of delay values to the WD; and receiving from the WD a report that includes a set of correlation values, the set of correlation values determined by the WD, the correlation values corresponding to the set of delay values.

According to this aspect, in some embodiments, the set of delay values is transmitted via Radio Resource Control, RRC, signaling. In some embodiments, the reference signal symbols are tracking reference signal, TRS, symbols. In some embodiments, a subset of the set of delay values is associated with a periodicity of a TRS burst. In some embodiments, the method includes receiving a number of correlations the WD is configured to perform. In some embodiments, the set of correlation values are quantized correlation values. In some embodiments, the set of correlation values are absolute correlation values. In some embodiments, the set of correlation values are relative to a value of 1. In some embodiments, the set of correlation values are normalized correlation values. In some embodiments, the method includes determining a velocity range of the WD based at least in part on the correlation values. In some embodiments, the method includes deactivating reporting of correlation values that correspond to a subset of the set of delay values. In some embodiments, transmitting the set of delay values includes transmitting a bitmap indicating which of n autocorrelation values are to be reported by the WD. In some embodiments, transmitting the set of delay values includes transmitting positive integers a and b indicating a beginning time and ending time for the WD to determine correlation values. In some embodiments, transmitting the set of delay values includes transmitting a threshold to which the WD compares each correlation value to decide whether to include the correlation value in the report.

According to yet another aspect, a wireless device, WD, configured to communicate with a network node is provided. The WD is configured to receive from the network node a set of delay values, each delay value in the set of delay values being a separation in time between reference signal symbols used for determining correlation values. The WD is configured to receive from the network node a configuration to measure a first set of correlation values corresponding to the set of delay values, measure the first set of correlation values corresponding to the set of delay values according to the configuration, and transmit to the network node a second set of correlation values, the second set of correlation values including at least a subset of the first set of correlation values.

According to this aspect, in some embodiments, the set of delay values is received via Radio Resource Control, RRC, signaling. In some embodiments, the reference signal symbols are tracking reference signal, TRS, symbols. In some embodiments, a subset of the set of delay values is associated with a periodicity of a TRS burst. In some embodiments, the WD is configured to report a number of correlations the WD is configured to perform. In some embodiments, the second set of correlation values are correlation values of the first set of correlation values that are above a threshold. In some embodiments, the threshold is based at least in part on a delay between TRS over which a correlation is determined. In some embodiments, the second set of correlation values are quantized values of the first set of correlation values. In some embodiments, a first transmitted correlation value is an absolute value and remaining transmitted correlation values in the second set of correlation values are differential values. In some embodiments, the transmitted second set of correlation values are absolute values. In some embodiments, the transmitted second set of correlation values are relative to a value of 1. In some embodiments, the transmitted second set of correlation values are normalized correlation values.

According to another aspect, a method in a wireless device (WD) configured to communicate with a network node is provided. The method includes: receiving from the network node a set of delay values, each delay value in the set of delay values being a separation in time between reference signal symbols used for determining correlation values; receiving from the network node a configuration to measure a first set of correlation values corresponding to the set of delay values; measure the first set of correlation values corresponding to the set of delay values according to the configuration; and transmitting to the network node a second set of correlation values, the second set of correlation values including at least a subset of the first set of correlation values.

According to this aspect, in some embodiments, the set of delay values is received via Radio Resource Control, RRC, signaling. In some embodiments, the reference signal symbols are tracking reference signal, TRS, symbols. In some embodiments, a subset of the first set of delay values is associated with a periodicity of a TRS burst. In some embodiments, the WD is configured to report a number of correlations the WD is configured to perform. In some embodiments, the second set of correlation values are correlation values of the first set of correlation values that are above a threshold. In some embodiments, the threshold is based at least in part on a delay between TRS over which a correlation is determined. In some embodiments, the second set of correlation values are quantized values of the first set of correlation values. In some embodiments, a first transmitted correlation value is an absolute value and remaining transmitted correlation values in the second set of correlation values are differential values. In some embodiments, the transmitted second set of correlation values are absolute values. In some embodiments, the transmitted second set of correlation values are relative to a value of 1. In some embodiments, the transmitted second set of correlation values are normalized correlation values.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of RE allocation for a 12-port CSI-RS in NR;

FIG. 2 is an example of RE allocation for a TRS burst with 2 TRS symbols in 2 adjacent slots;

FIG. 3 is an illustration of configurability of TRS symbol positions and TRS burst periodicity;

FIGS. 4 and 5 are graphs of relative mean user throughput versus WD speed for reciprocity- and feedback-based CSI;

FIGS. 6 and 7 are graphs of mean user throughput versus WD speed for Type I and Type II CSI;

FIG. 8 illustrates delays τ_k for which the correlation may be estimated based on intra TRS burst measurements using the TRS signal;

FIG. 9 is a schematic diagram of an example network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating example methods implemented in a communication system including a host computer, a network node and a wireless device for executing a client application at a wireless device according to some embodiments of the present disclosure;

FIG. 12 is a flowchart illustrating example methods implemented in a communication system including a host computer, a network node and a wireless device for receiving user data and/or executing a client application at a wireless device according to some embodiments of the present disclosure;

FIG. 13 is a flowchart illustrating example methods implemented in a communication system including a host computer, a network node and a wireless device for receiving user data from the wireless device at a host computer according to some embodiments of the present disclosure;

FIG. 14 is a flowchart illustrating example methods implemented in a communication system including a host computer, a network node and a wireless device for receiving user data from the wireless device at a host computer according to some embodiments of the present disclosure;

FIG. 15 is a flowchart of an example process in a network node for methods for tracking reference signal (TRS)-based time domain channel property (TDCP) reporting;

FIG. 16 is a flowchart of an example process in a wireless device for methods for tracking reference signal (TRS)-based time domain channel property (TDCP) reporting;

FIG. 17 is a flowchart of another example process in a network node for methods for tracking reference signal (TRS)-based time domain channel property (TDCP) reporting;

FIG. 18 is a flowchart of another example process in a wireless device for methods for tracking reference signal (TRS)-based time domain channel property (TDCP) reporting;

FIG. 19 is a flowchart of an example process in a network node for dynamically updating measurement parameters for correlation-based time domain channel property (TDCP) reporting;

FIG. 20 is a flowchart of an example process in a wireless device for dynamically updating measurement parameters for correlation-based time domain channel property (TDCP) reporting;

FIG. 21 is a zeroth order Bessel function of the first kind;

FIG. 22 is a table of correlation values for different delays and velocities based on the zeroth order Bessel function of the first kind;

FIG. 23 illustrates absolute and differential correlation value reporting;

FIG. 24 is a graph of error in autocorrelation estimate;

FIG. 25 is an example of reference signals for channel correlation measurement;

FIG. 26 is an example of periodic correlation reporting; and

FIG. 27 is an example of reporting correlations above a threshold of 0.5.

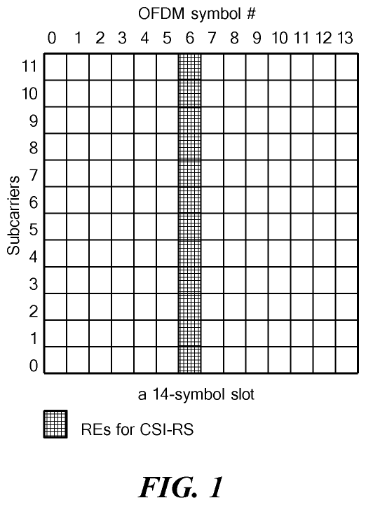

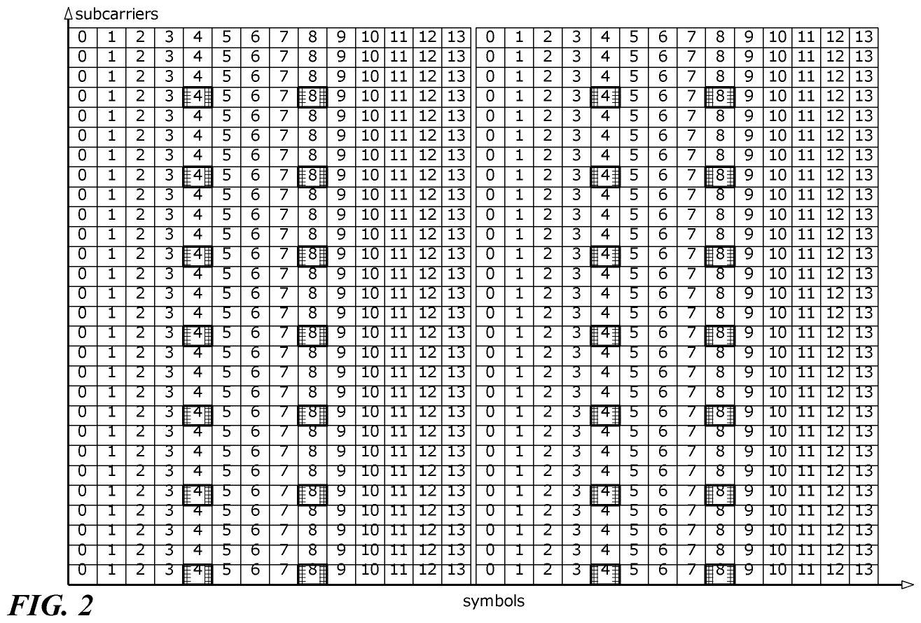

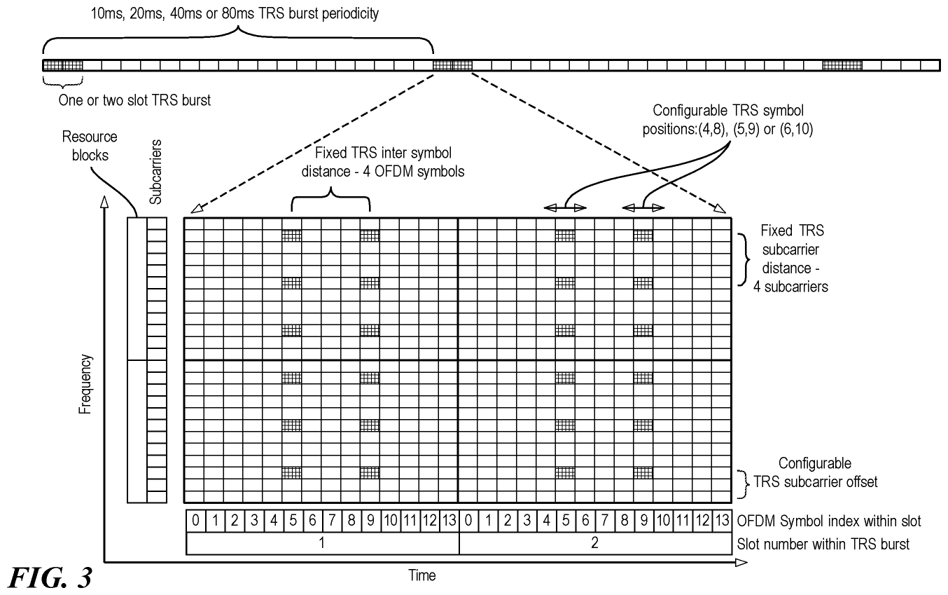

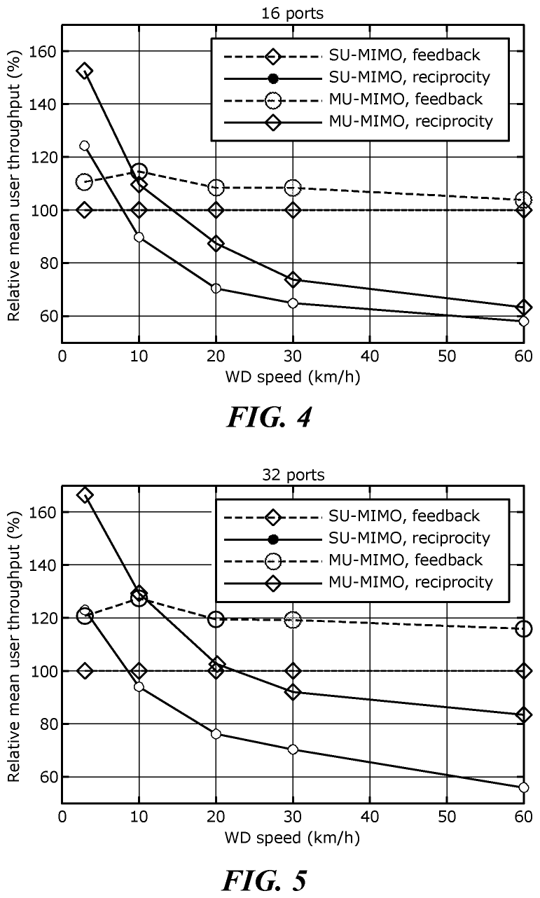

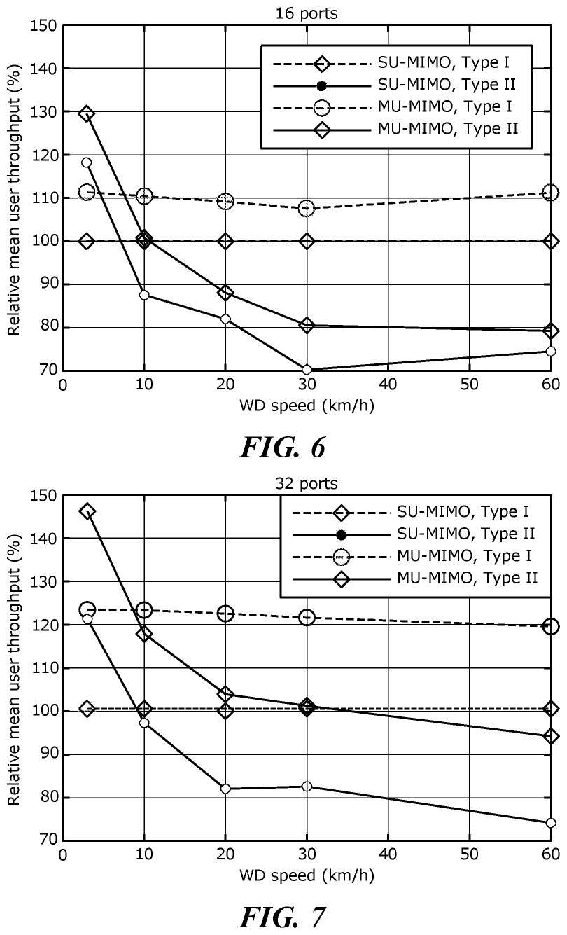

### DETAILED DESCRIPTION

Before describing in detail example embodiments, it is noted that the embodiments reside primarily in combinations of apparatus components and processing steps related to methods for tracking reference signal (TRS)-based time domain channel property (TDCP) reporting and for dynamically updating measurement parameters for correlation-based time domain channel property (TDCP) reporting. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods for tracking reference signal (TRS)-based time domain channel property (TDCP) reporting and for dynamically updating measurement parameters for correlation-based time domain channel property (TDCP) reporting.

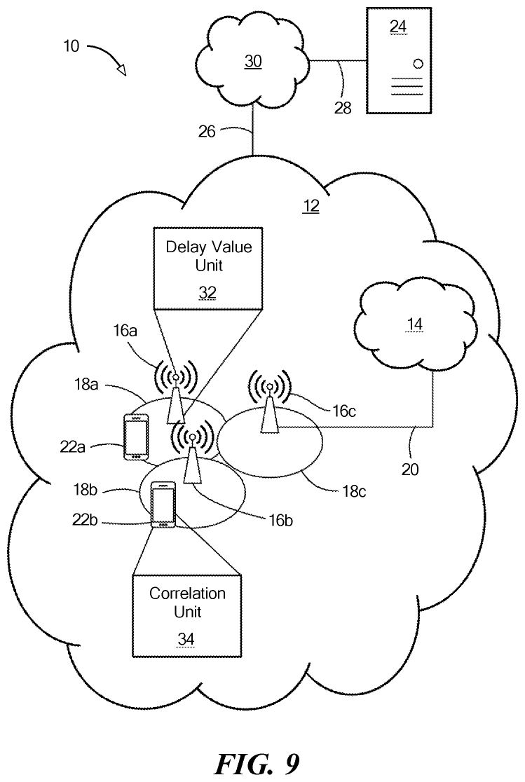

Returning now to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-Universal Terrestrial Radio Access Network (UTRAN) and a gNB for NR/Next Generation (NG)-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a delay value unit 32 which is configured to determine a set of delay values, each delay value of the set of delay values being a separation in time between reference signal symbols used to determine correlation values. A wireless device 22 is configured to include a correlation unit 34 which is configured to measure a first set of correlation values corresponding to the set of delay values according to the configuration.

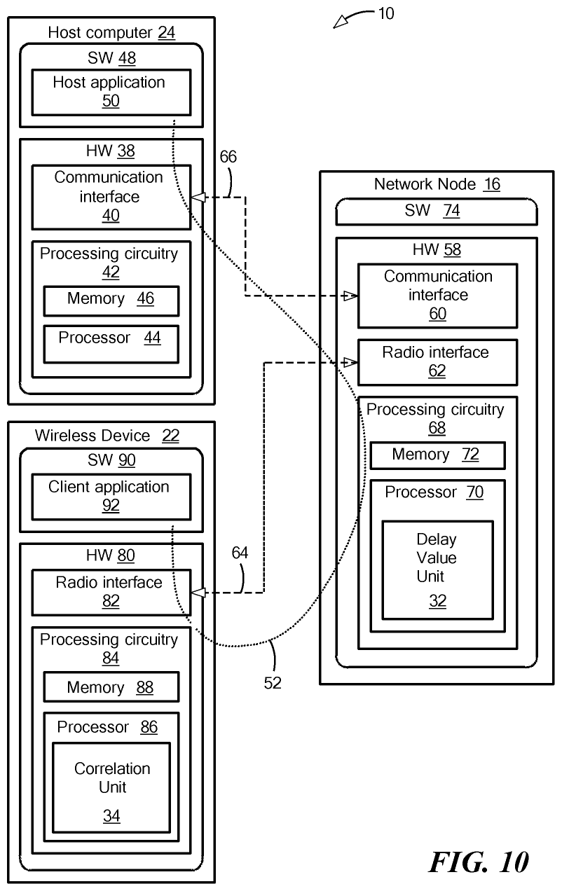

Example implementations, in accordance with an embodiment, of the WD 22, network node 16 and host computer 24 discussed in the preceding paragraphs will now be described with reference to FIG. 10. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a delay value unit 32 which is configured to determine a set of delay values, each delay value of the set of delay values being a separation in time between reference signal symbols used to determine correlation values.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a correlation unit 34 which is configured to measure a first set of correlation values corresponding to the set of delay values according to the configuration.

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 9 and 10 show various “units” such as delay value unit 32, and correlation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

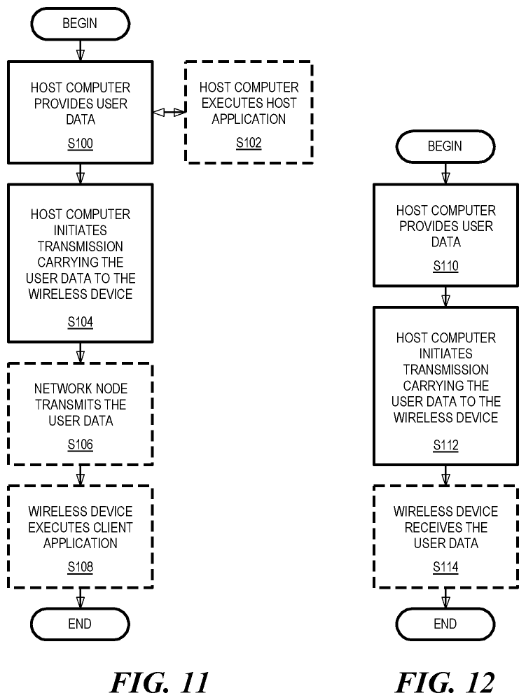

FIG. 11 is a flowchart illustrating an example method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

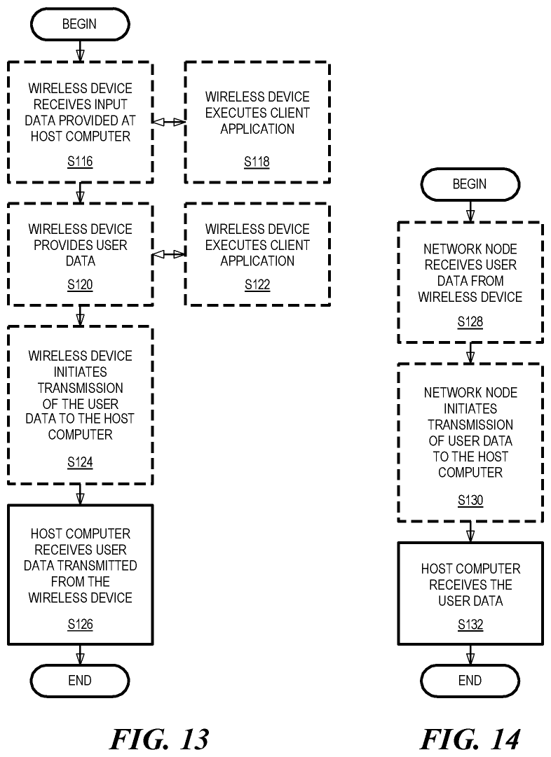

FIG. 13 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

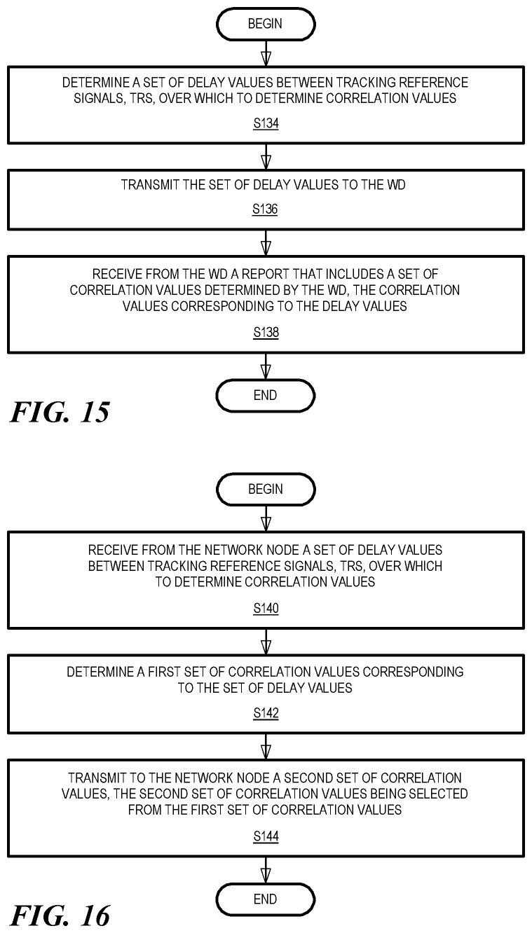

FIG. 15 is a flowchart of an example process in a network node 16 for methods for tracking reference signal (TRS)-based time domain channel property (TDCP) reporting. One or more blocks described herein may be performed by one or more elements of network node 16 such as by one or more of processing circuitry 68 (including the delay value unit 32), processor 70, radio interface 62 and/or communication interface 60. Network node 16 such as via processing circuitry 68 and/or processor 70 and/or radio interface 62 and/or communication interface 60 is configured to determine a set of delay values between tracking reference signals, TRS, over which to determine correlation values (Block S134). The process also includes transmitting the set of delay values to the WD (Block S136). The process further includes receiving from the WD a report that includes a set of correlation values determined by the WD, the correlation values corresponding to the delay values (Block S138).

In some embodiments, transmitting the delay values includes transmitting a bitmap indicating which of n autocorrelation values to be reported by the WD. In some embodiments, transmitting the delay values includes transmitting positive integers a and b indicating a beginning time and ending time for the WD to determine correlation values. In some embodiments, transmitting the delay values includes transmitting a threshold to which the WD compares each correlation value to decide whether to include the correlation value in the report.

FIG. 16 is a flowchart of an example process in a wireless device 22 according to some embodiments of the present disclosure. One or more blocks described herein may be performed by one or more elements of wireless device 22 such as by one or more of processing circuitry 84 (including the correlation unit 34), processor 86, radio interface 82 and/or communication interface 60. Wireless device 22 such as via processing circuitry 84 and/or processor 86 and/or radio interface 82 is configured to receive from the network node a set of delay values between tracking reference signals, TRS, over which to determine correlation values (Block S140). The process also includes determining a first set of correlation values corresponding to the set of delay values (Block S142). The process further includes transmitting to the network node a second set of correlation values, the second set of correlation values being selected from the first set of correlation values (Block S144).

In some embodiments, the second set of correlation values are correlation values of the first set of correlation values that are above a threshold. In some embodiments, the threshold is based at least in part on a delay between TRS over which a correlation is determined. In some embodiments, the second set of correlation values are quantized values of the first set of correlation values. In some embodiments, a first transmitted correlation value is an absolute value and remaining transmitted correlation values in the second set of correlation values are differential values. In some embodiments, the transmitted second set of correlation values are relative to a value of 1.

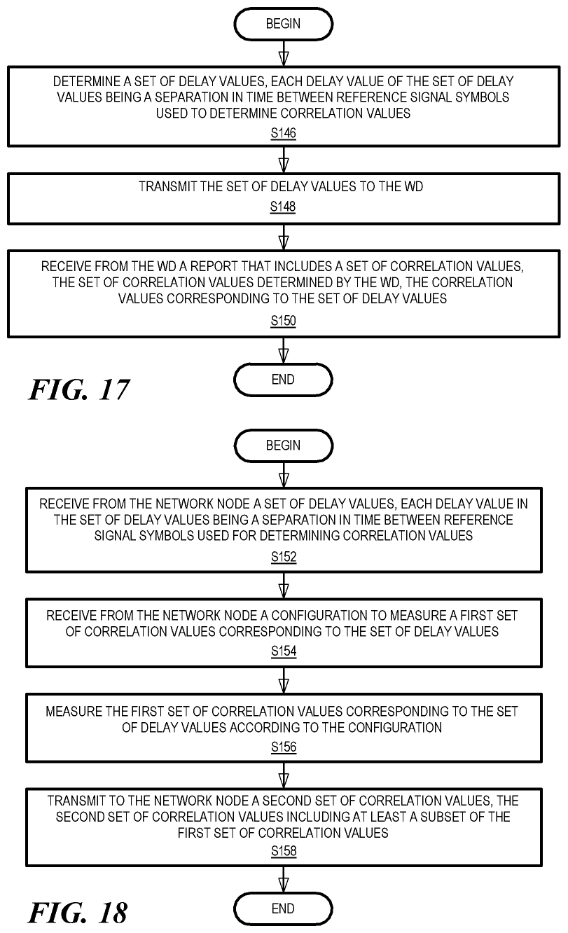

FIG. 17 is a flowchart of an example process in a network node 16 for methods for tracking reference signal (TRS)-based time domain channel property (TDCP) reporting. One or more blocks described herein may be performed by one or more elements of network node 16 such as by one or more of processing circuitry 68 (including the delay value unit 32), processor 70, radio interface 62 and/or communication interface 60. Network node 16 such as via processing circuitry 68 and/or processor 70 and/or radio interface 62 and/or communication interface 60 is configured to determine a set of delay values, each delay value of the set of delay values being a separation in time between reference signal symbols used to determine correlation values (S146). The process includes transmitting the set of delay values to the WD 22 (Block S148). The process includes receiving from the WD 22 a report that includes a set of correlation values, the set of correlation values determined by the WD 22, the correlation values corresponding to the set of delay values (Block S150).

In some embodiments, the set of delay values is transmitted via Radio Resource Control, RRC, signaling. In some embodiments, the reference signal symbols are tracking reference signal, TRS, symbols. In some embodiments, a subset of the set of delay values is associated with a periodicity of a TRS burst. In some embodiments, the method includes receiving a number of correlations the WD 22 is configured to perform. In some embodiments, the set of correlation values are quantized correlation values. In some embodiments, the set of correlation values are absolute correlation values. In some embodiments, the set of correlation values are relative to a value of 1. In some embodiments, the set of correlation values are normalized correlation values. In some embodiments, the method includes determining a velocity range of the WD 22 based at least in part on the correlation values. In some embodiments, the method includes deactivating reporting of correlation values that correspond to a subset of the set of delay values. In some embodiments, transmitting the set of delay values includes transmitting a bitmap indicating which of n autocorrelation values are to be reported by the WD 22. In some embodiments, transmitting the set of delay values includes transmitting positive integers a and b indicating a beginning time and ending time for the WD 22 to determine correlation values. In some embodiments, transmitting the set of delay values includes transmitting a threshold to which the WD 22 compares each correlation value to decide whether to include the correlation value in the report. FIG. 18 is a flowchart of an example process in a wireless device 22 according to some embodiments of the present disclosure. One or more blocks described herein may be performed by one or more elements of wireless device 22 such as by one or more of processing circuitry 84 (including the correlation unit 34), processor 86, radio interface 82 and/or communication interface 60. Wireless device 22 such as via processing circuitry 84 and/or processor 86 and/or radio interface 82 is configured to receive from the network node 16 a set of delay values, each delay value in the set of delay values being a separation in time between reference signal symbols used for determining correlation values (Block S152). The process includes receiving from the network node 16 a configuration to measure a first set of correlation values corresponding to the set of delay values (Block S154); measure the first set of correlation values corresponding to the set of delay values according to the configuration (Block S156); and transmitting to the network node 16 a second set of correlation values, the second set of correlation values including at least a subset of the first set of correlation values (Block S158).

In some embodiments, the set of delay values is received via Radio Resource Control, RRC, signaling. In some embodiments, the reference signal symbols are tracking reference signal, TRS, symbols. In some embodiments, a subset of the first set of delay values is associated with a periodicity of a TRS burst. In some embodiments, the WD 22 is configured to report a number of correlations the WD 22 is configured to perform. In some embodiments, the second set of correlation values are correlation values of the first set of correlation values that are above a threshold. In some embodiments, the threshold is based at least in part on a delay between TRS over which a correlation is determined. In some embodiments, the second set of correlation values are quantized values of the first set of correlation values. In some embodiments, a first transmitted correlation value is an absolute value and remaining transmitted correlation values in the second set of correlation values are differential values. In some embodiments, the transmitted second set of correlation values are absolute values. In some embodiments, the transmitted second set of correlation values are relative to a value of 1. In some embodiments, the transmitted second set of correlation values are normalized correlation values.

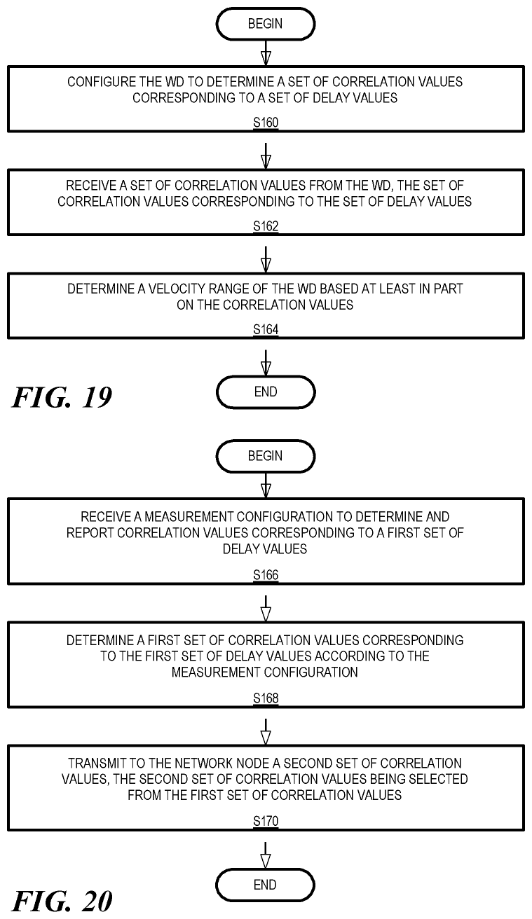

FIG. 19 is a flowchart of an example process in a network node 16 for method for dynamic update of measurement parameters for correlation-based time domain channel property (TDCP) reporting. One or more blocks described herein may be performed by one or more elements of network node 16 such as by one or more of processing circuitry 68 (including the velocity unit 32), processor 70, radio interface 62 and/or communication interface 60. Network node 16 such as via processing circuitry 68 and/or processor 70 and/or radio interface 62 and/or communication interface 60 is configured to configure the WD 22 to determine a set of correlation values corresponding to a set of delay values (Block S160). The process also includes receiving a set of correlation values from the WD 22, the set of correlation values corresponding to the set of delay values (Block S162). The process also includes determining a velocity range of the WD 22 based at least in part on the correlation values (Block S164).

In some embodiments, the method includes updating the set of delay values based at least in part on the velocity range. In some embodiments, the velocity range is determined based at least in part on a comparison of the correlation values to a threshold. In some embodiments, the comparison is performed by the WD 22.

FIG. 20 is a flowchart of an example process in a wireless device 22 according to some embodiments of the present disclosure. One or more blocks described herein may be performed by one or more elements of wireless device 22 such as by one or more of processing circuitry 84 (including the correlation unit 34), processor 86, radio interface 82 and/or communication interface 60. Wireless device 22 such as via processing circuitry 84 and/or processor 86 and/or radio interface 82 is configured to receive a measurement configuration to determine and report correlation values corresponding to a first set of delay values (Block S166). The process also includes determining a first set of correlation values corresponding to the first set of delay values according to the measurement configuration (Block S168). The process also includes transmitting to the network node a second set of correlation values, the second set of correlation values being selected from the first set of correlation values (Block S170).

In some embodiments, the first set of delay values are relative to a tracking reference signal, TRS, burst. In some embodiments, the process also includes reporting a number of correlations the WD 22 is configured to perform. In some embodiments, a subset of the delay values is associated with a periodicity of a tracking reference signal, TRS, burst.

Having described the general process flow of arrangements of the disclosure and having provided examples of hardware and software arrangements for implementing the processes and functions of the disclosure, the sections below provide details and examples of arrangements for methods for tracking reference signal (TRS)-based time domain channel property (TDCP) reporting and for dynamic update of measurement parameters for correlation-based time domain channel property (TDCP) reporting.

The term “correlation values” is used herein. In some embodiments, the correlation values may be autocorrelation values. In some embodiments, the correlation values may be either normalized or non-normalized time domain correlation values.

Some embodiments apply the amplitude of the measured or estimated correlation values. Some embodiments apply the real part of the measured or estimated correlation values. Some embodiments apply the real part and the imaginary part of the measured or estimated correlation values separately (i.e., some embodiments are applied first to the real part and then applied to the imaginary part).

The doppler spectrum for a homogenous channel may be modeled using the Jake's model (i.e., in two dimensions) as follows:

$$S ( f ) = \{ \begin{matrix}\frac{1}{π \cdot {f}_{max}} . \frac{1}{\sqrt{1 - ( \frac{f}{{f}_{max}} )}} & ( \vert f \vert \leq {f}_{max} ) \\ 0 & ( \vert f \vert > {f}_{max} )\end{matrix}$$

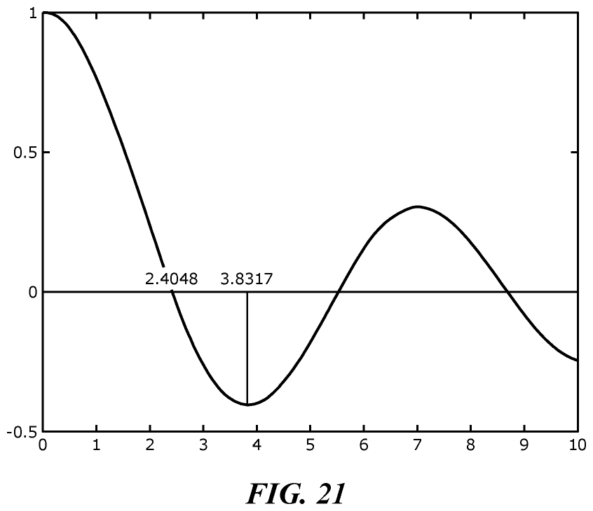

and the autocorrelation which is the inverse Fourier transform of the doppler spectrum is equal to J₀(2π·τ·fₘₐₓ), where J₀(·) is the zeroth order Bessel function of the first kind, and the doppler spread may be estimated by fₘₐₓ. FIG. 21 shows a graph of example of the zeroth order Bessel function of the first kind.

The estimated Doppler spread may be translated to an estimate of the WD velocity as

$$v = \frac{c \cdot {f}_{max}}{2 \cdot {f}_{carrier}}$$

where f_{carrier} is the carrier frequency, c is the speed of light and f_{D} is the estimated Doppler spread.

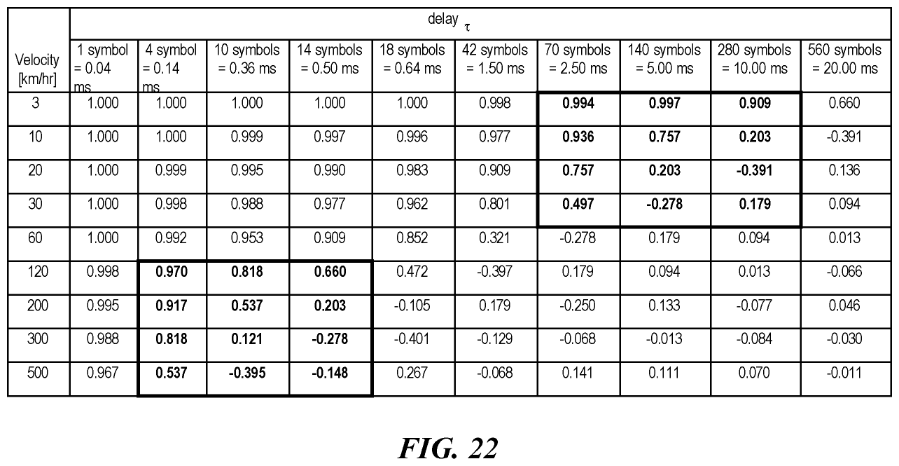

FIG. 22 is a chart showing example correlation values for different WD velocities at different delay (τ) values given in units of ms at 3.5 GHz carrier frequency. The correlation values are computed using the zeroth order Bessel function of the first kind. Note that a 30 kHz subcarrier spacing is assumed in FIG. 16 (i.e., a one slot delay or a 14 symbol delay corresponds to a delay of 0.5 ms).

As shown in FIG. 22, at low velocities, the correlation values change very slowly over small delay values of 4, 10, 14, and 18 symbols, which corresponds to delays within a TRS burst. For example, at 3 km/hr, the correlation value does not change at all for delay values of 4, 10, 14, and 18 symbols. At 10 km/hr, the correlation value changes by 0.001 to 0.004 as the delay value is increased from 4 symbols to Oct. 14, 2018 symbols. Such small changes may be difficult to detect as there will be estimation errors when the WD 22 estimates the correlation value. Hence, it is challenging to distinguish between low velocities (e.g., between 3 km/hr and 10 km/hr) using delays within a TRS burst (e.g., delays of 4, 10, 14, and 18 symbols).

To distinguish between different low velocities, higher delay values which correspond to inter TRS bursts may be needed. For example, the delays corresponding the shaded area in the upper right of FIG. 22 may be used to distinguish between different low velocities. However, it should be noted that the changes in correlation values for different velocities differs when the delay is increased from 2.5 ms to 5 ms to 10 ms. In the example of FIG. 22, the following may be observed:
at 3 km/hr: the correlation value changes by 0.003 when delay t is increased from 2.5 ms to 5 ms; the correlation value changes by 0.085 when delay T is increased from 2.5 ms to 10 ms;
at 10 km/hr: the correlation value changes by 0.179 when delay t is increased from 2.5 ms to 5 ms; the correlation value changes by 0.733 when delay t is increased from 2.5 ms to 10 ms;
at 20 km/hr: the correlation value changes by 0.554 when delay t is increased from 2.5 ms to 5 ms; the correlation value changes by 1.148 when delay t is increased from 2.5 ms to 10 ms; and
at 30 km/hr: the correlation value changes by 0.775 when delay t is increased from 2.5 ms to 5 ms; the correlation value changes by 0.318 when delay t is increased from 2.5 ms to 10 ms.

It is notable that the change in correlation depends on both the velocity as well as the change in delay τ. A similar observation may be made for higher velocities. For higher velocities, the correlation values change notably even for small delay values of 4, 10, 14, and 18 symbols, which correspond to delays within a TRS burst. Hence, in the example of FIG. 22, the delays corresponding to the shaded area in the lower left of FIG. 22 may be used to distinguish between different high velocities.

From the above analysis, it may be seen that to cover WD 22 speeds from low to high, a WD 22 should measure and report correlations at both small and large delays, which may be costly in terms of implementation and feedback overhead.

In some embodiments, a method is disclosed to reduce the WD's measurement and computational complexity when measuring correlation values corresponding to multiple delay (τ) values. In some embodiments, a method may include one or more of the following steps.

Step 1: The WD 22 receives a configuration from the network node 16 to measure and report correlation values corresponding to a first set of delay (τ) values:
In some embodiments, the first set of delay (τ) values that the WD 22 may measure and calculate correlation values for, are explicitly configured (e.g., via RRC signaling);
In some embodiments, the first set of delay (τ) values configured in Step 1 are the delay values within a TRS burst (e.g., τ values corresponding to 4 symbols, 10 symbols, 14 symbols and 18 symbols). In some embodiments, the delay (τ) values configured in Step 1 are a subset of the values of 4 symbols, 10 symbols, 14 symbols and 18 symbols;
In some embodiments, the values of the first set of delay (τ) values in Step 1 are pre-determined and specified in 3GPP specifications. In some embodiments, the values of the first set of delay (τ) values in Step 1 are the delays values within a TRS burst (e.g., τ values corresponding to 4 symbols, 10 symbols, 14 symbols and 18 symbols). It is also possible that the delay (τ) values in Step 1 are a subset of the values of 4 symbols, 10 symbols, 14 symbols and 18 symbols;
In some embodiments, the number of delay (τ) values for which the WD 22 may measure correlation values is configured to the WD 22 (e.g., via RRC signaling). The number of delay (τ) values for which the WD 22 may measure correlation values may be a WD 22 capability; hence, the WD 22 may report how many delay (τ) values for which the WD 22 may measure correlation values. In some embodiments, the configuration of the number of delay (τ) values in the first set of delays (e.g., via RRC signaling) by the network node 16 to the WD 22 is based on the capability reported by the WD 22;
In some embodiments, the number of delay (τ) values for which the WD 22 may measure correlation values is pre-determined and specified in 3GPP specifications;
In some embodiments, a subset of delay (τ) values in Step 1 is associated with the periodicity T configured by “periodicityAndOffset” (CSI-ResourcePeriodicityAndOffset as specified in 3GPP Technical Standard (TS) 38.331) in NZP-CSI-RS-ResourceSet when trs-Info in NZP-CSI-RS-ResourceSet is set to ‘True’:
   In some embodiments, the WD 22 expects the delay value to be a multiple of the periodicity T of the TRS configuration, i.e., τ=M*T, where M is of integer values start from 1, i.e., 1,2,3 . . . . The range of M may be dependent on WD capability;
In some embodiments, the delay values may be generalized with a formula, τ=M*T*14+A, where T is in time unit of slot as configured in TRS configuration, A is in time unit of symbols may be defined as at least one of the values from (0, 4, 10, 14, 18), M is of integer values start from 0, i.e., 0,1,2 . . . . Both the range of M and A may be dependent on WD 22 capability;

Step 2: the WD 22 measures correlation values on the first set of delay (τ) values in Step 1;

Step 3: the WD 22 reports to the network node 16, correlation values measured in Step 2. In some embodiments, a subset of correlation values measured in Step 2 are reported to the network node 16 (e.g., only correlation values beyond a certain threshold may be reported); and/or

Step 4: the network node 16 receives correlation value reports from the WD 22 and makes a decision on whether or not to update the first set of delay (τ) values for which the WD 22 may measure correlation values:

In one scenario, the reported correlations in Step 3 correspond to intra-burst correlations where the first set of delay (τ) values (i.e., the t values for which the WD 22 has measured correlation values and reported those correlation values as in Steps 1-3) are within a TRS burst. In this case, for example:
If the reported correlation values change notably within these delays, then the network node 16 may determine that the WD 22 is likely operating with mid to high WD 22 velocity (e.g., velocity between 30 km/hr to 120 km/hr). Hence, the network node 16 may determine that feedback-based precoding may be used instead of reciprocity-based CSI acquisition. Alternatively, the network node 16 may choose to use Type I CSI feedback over Type II CSI feedback. As a result, the network node 16 may not need to update set of delay (τ) values for which the WD 22 may measure correlation values, and the WD 22 may continue with Steps 2-3;
Otherwise, if the reported correlation values do not change notably within these delays, then the network node 16 may determine that the WD 22 is likely operating with low WD 22 velocity (e.g., velocity between 3 km/hr to 20 km/hr). However, this information may not be enough to determine what precoding scheme may be used for this WD 22. Recall that the network node 16 may distinguish between WD 22 speeds of 3 km/hr vs 10 km/hr or higher in order to decide what precoding scheme to use for this WD 22. Hence, the network node 16 may decide to update the first set of delay (τ) values to include delays corresponding to TRSs located in different TRS bursts (e.g., delay (τ) values corresponding to inter TRS bursts separated by 5 slots, 10 slots, 20 slots, 40 slots, etc.). In this case, the network node 16 updates the set of delay values following Step 5 below;

In another scenario, the reported correlations in Step 3 correspond to inter-burst correlations where the first set of delay (τ) values (i.e., the t values for which the WD 22 has measured correlation values and reported those correlation values as in Steps 1-3) are between TRS bursts, e.g., τ=5 ms, 10 ms, 20 ms, etc. In this case:
If the reported correlation values are all below a threshold, e.g., 0.5, then the network node 16 may determine that the WD is likely operating with mid to high WD velocity. If the network node 16 wants to further determine a finer range of the WD speed, it may update the first set of delay (τ) values corresponding to intra-burst delays for which the WD 22 may measure correlation values, and the WD 22 may continue with Steps 2-3. Otherwise, if the information of mid to high WD velocity is enough for the network node 16, it may not update the first set of delay (τ) values. For the example shown in FIG. 22, if reported correlation values at τ=5, 10, and 20 ms are all less than 0.5, then the network node 16 may determine that the WD velocity is greater than 20 km/h, and if this information is enough for the network node 16, the first set of delays may not be updated;
On the other hand, if some of the reported correlation values are above a threshold, e.g., 0.5, then the network node 16 may determine that the WD 22 is likely operating with low WD velocity and the velocity range may be further determined by the reported correlation values at different delays. In this case, the network node 16 may not update the set of delay (T) values. For the example shown in FIG. 22, if reported correlation value at τ=10 ms or τ=20 ms is above 0.5, then the network node 16 may determine that the WD velocity is less than 10 km/h, and this information may be enough for the network node 16 and the first set of delays may not be updated;

Step 5: WD 22 receives from network node 16 signaling to update the set of delay (T) values to measure and report correlation values.

### Embodiments for Reporting of Correlation Values

In some embodiments, the WD 22 measures or estimates the correlation values corresponding to multiple τ delay values. The WD 22 may then report the measured or estimated correlation values to the network node 16. In some cases, a subset of the measured or estimated correlation values are reported to the network node 16 by the WD 22. In another case, all the measured or estimated correlation values are reported to the network node 16 by the WD 22.

In some embodiments, the delay values t for which the WD 22 should measure or estimate and then report the correlation values to the network node 16 are signaled to the WD 22. The signaling to the WD 22 from the network node 16 may be through RRC (radio resource configuration), MAC CE (medium access control control element) signaling, downlink control information (DCI) signaling, or a combination of these types of signaling.

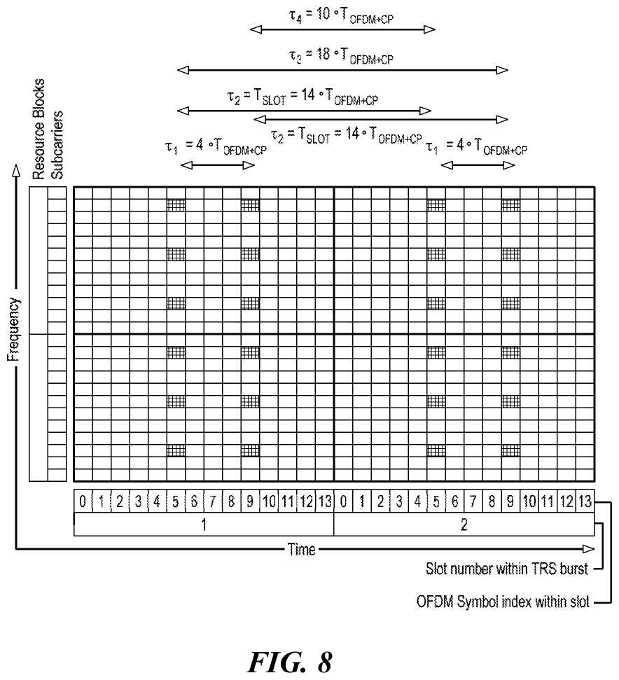

In some embodiments, the signaling of delay values is dependent on the reference signal or reference signals to be used for the measurements. For example, assume that the reference signal or reference signals to be used for the measurements allow for estimates of the autocorrelation for a number of different autocorrelation time lags τ₁<τ₂<···<τₙ (i.e., the reference signal(s) utilize resource elements separated in time by the these time lags). In some embodiments, the network node 16 signals to the WD 22 a bitmap of length n indicating which of the n autocorrelation lags to measure and report. In some embodiments the network node 16 signals to the WD 22 two positive integers a and b to indicate to the WD 22 to measure and report the autocorrelation for the lags τₐ<τₐ₊₁< . . . <τ_{b}. As an example, the autocorrelation lags for which measurements may be performed based on a single two slot TRS burst are illustrated in FIG. 8.

Note that for τ₁=4·T_{OFDM+CP} and for τ₂=T_{SLOT}=14·T_{OFDM+CP} there are two samples within the TRS burst that may be used for the measurement, while for τ₃=18·T_{OFDM+CP} and τ₄=10·T_{OFDM+CP} there is only one sample within the TRS burst that may be used for the measurement.

In some embodiments, the allowed autocorrelation lags for measurements based on a periodic dual slot TRS burst with periodicity τ_{TRS} is given by τ₁<τ₂<τ_{TRS}<2τ_{TRS}<4τ_{TRS} . . . <2ⁿτ_{TRS}, for some positive integer n and where τ₁ and τ₂ are shown in FIG. 8. The methods described above for signaling a subset of these autocorrelation lags for WD measurement and/or reporting may be applied.

In some embodiments, the delay values τ for which the WD 22 should measure or estimate the correlation values to the network node 16 are signaled to the WD 22. Which of the measured or estimated correlation values to be reported to the network node 16 is decided by the WD 22. In some embodiments, the WD 22 only reports correlation values that are above a threshold Corrₜₕ. The threshold Corrₜₕ value may be predefined in 3GPP specifications. Alternatively, the threshold Corrₜₕ may be signaled to the WD 22 from the network node 16 through RRC, MAC CE signaling, DCI signaling, or a combination of these types of signaling.

For example, consider a WD 22 with velocity 10 km/hr that is configured/signaled to measure or estimate correlation values for delays of τ₁=70 symbols, τ₂=140 symbols, and τ₃=280 symbols. Assume that the measured or estimated correlation values corresponding to these delays are as given in FIG. 16. In this example, if the threshold Corrₜₕ=0.5, then the WD 22 should only report correlation values of 0.936 (corresponding to τ₁=70 symbols) and 0.757 (corresponding to τ₂=140 symbols) as these values are above the threshold Corrₜₕ=0.5. The measured or estimated correlation value of 0.203 (corresponding to τ₃=280 symbols) should not be reported as this value is below the threshold Corrₜₕ=0.5.

In some embodiments, the payload size of the report may vary depending on the number of correlations above the threshold. To facilitate network node 16 decoding of the report, the report may have two parts, the first part containing the number of reported correlations and has a fixed/known payload size. The second part contains the reported correlations and the associated delays. The two parts are encoded separately and the network node 16 first decodes the first part to determine the number of reported correlations and thus, the payload size of the second part. The network node 16 then decodes the second part to obtain the reported correlations {corr_k} and the corresponding delays {τ_k}.

In some embodiments, the WD 22 reports a fixed number M of pairs of delay(s) and the corresponding correlation(s) under the condition that the correlation(s) are higher than and/or equal to a threshold, where M is equal to or smaller than the total number of configured/signal/measured delays. This means the payload size is always fixed despite estimated correlation values for configured delays. For example, M=2, one maximum correlation delay pair and one minimum correlation delay pair are reported; or for another example, M=3, a first and a second maximum correlation delay pair is reported. If the number of correlation measurements fulfill the threshold criteria is smaller than the preconfigured/fixed number M, a predefined value/indication is used to indicate the invalid correlation value. In some embodiments, the WD 22 should report the corresponding delay(s) closest to the threshold even for invalid correlation values.

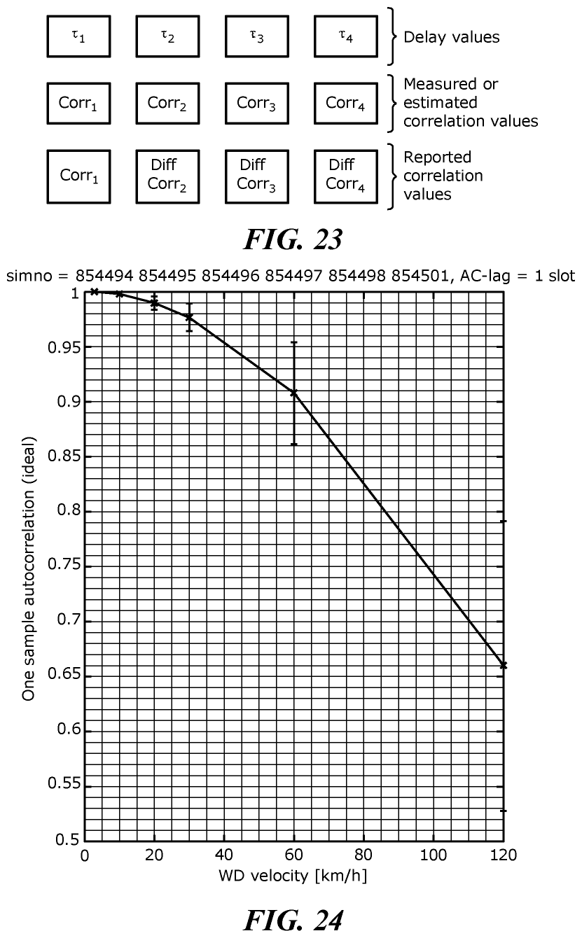

In some embodiments, the WD 22 reports one of the measured or estimated correlation values as absolute value and the remaining measured or estimated correlation values as differential or relative values. One example of such an embodiment is shown in FIG. 23, where the WD 22 is signaled to measure correlation values for four different delays τ₁, τ₂, τ₃ and τ₄. Once the WD 22 measures or estimates the correlation values, the WD 22 reports the measured or estimated correlation value corresponding to the smallest delay (e.g., Corrᵢ corresponding to τ₁ in FIG. 23) as an absolute value. In some embodiments, the WD 22 may quantize the measured or estimated correlation value to some quantized value from a predetermined set of values (i.e., a value in the predetermined set of values that is closest to the measured or estimated correlation value), and the WD 22 may report the quantized correlation value. For the remaining delays τ₂, τ₃ and τ₄, the WD 22 reports the relative of differential correlation values with respect to the reported correlation value corresponding to τ₁. The quantized value may be given in either linear scale or be given in decibels (dBs). The reported differential or relative correlation values corresponding to delays τ₂, τ₃ and τ₄ may be computed by the WD 22 as follows:

Diff Corr₂=Corr₂−Corr₁

Diff Corr₃=Corr₃−Corr₁

Diff Corr₄=Corr₄−Corr₁

In some embodiments, the reported differential or relative correlation values corresponding to delays τ₂, τ₃ and τ₄ may be computed by the WD 22 as follows:

Diff Corr₂=Corr₂−Corr₁

Diff Corr₃=Corr₃−Corr₂

Diff Corr₄=Corr₄−Corr₃

In some embodiments, the reported differential or relative correlation values may also be quantized to values that are closest from a predetermined set of values.

In some embodiments, the predetermined set of values used to quantize the reported absolute correlation value Corr₁ may be different from the predetermined set of values used to quantize the reported differential/relative correlation values Diff Corr₂, Diff Corr₃, and Diff Corr₄. For instance, when the predetermined set of values used to quantize the reported absolute correlation value Corr₁ contains Y₁ different candidate values, then ┌log₂(Y₁)┐ bits may be used to report Corr₁. Since the range of values for differential or relative correlation values are smaller, the predetermined set of values used to quantize the reported differential/relative correlation values Diff Corr₂, Diff Corr₃, and Diff Corr₄ may contain Y₂ different candidate values where Y₂<Y₁. Hence, ┌log₂(Y₂)┐ bits may be used to report the differential/relative correlation values. Since fewer number of bits are used to report differential/relative correlation values compared to reporting absolute correlation values, this solution saves reporting overhead when compared to the case where absolute correlation values are reported for all delay values.

In some embodiments, all the correlation values corresponding to the different delays are reported as absolute values. In some embodiments, normalized correlations are reported within a value range of Corr_{threshold}<Corrₖ≤1, where 0≤Corr_{threshold}<1 is a configured or predetermined threshold, e.g., Corr_{threshold}=0.5. Each correlation may be quantized linearly with N bits, e.g., N=10. Alternatively, each correlation may be reported in dB, e.g., 20 log₁₀ (Corrₖ), and quantized with a step size of xdB, e.g., x=0.1.

In some embodiments, a larger number of bits may be used to quantize the correlation values corresponding to the first N₁ delays than the number of bits used to quantize the correlation values corresponding to the remaining delays. For instance, when N₁=1, the correlation value corresponding to delay τ₁ is quantized and reported with Z₁ bits, and the correlation values corresponding to delays τ₂, τ₃, and τ₄ are quantized and reported with Z₂ bits, where Z₁>Z₂.

In some embodiments, the predetermined sets of values used to quantize the reported absolute and differential/relative correlation values may be specified in 3GPP standard specifications. The mappings of the predetermined values to codepoints in the ┌log₂(Y₁)┐ bit bitmap (in the case of absolute correlation reporting) may also be specified in 3GPP standard specifications. Similarly, the mappings of the predetermined values to codepoints in the ┌log₂ (Y₂)┐ bit bitmap (in the case of differential/relative correlation reporting) may also be specified in 3GPP standard specifications.

In some embodiments, the WD 22 may only report differential/relative correlation values that are above a threshold Diff Corrₜₕ. The threshold Diff Corrₜₕ value may be predefined in 3GPP specifications. Alternatively, the threshold Diff Corrₜₕ may be signaled to the WD 22 from the network node 16 through RRC, MAC CE signaling, DCI signaling, or a combination of these types of signaling. Note that the threshold Diff Corrₜₕ used for differential/relative correlation value reporting may be different from the threshold Corrₜₕ used for absolute correlation value reporting. In some embodiments, instead of reporting correlation values, the WD 22 instead reports the correlation offset relative to a value of one, i.e., correlation_offset=1−|Correlation|. In some embodiments, the correlation offset is reported in dB, i.e., as 10 log₁₀ (correlation_offset)=10 log₁₀ (1−|Correlation|) and quantized with a step size of x dB, e.g., x=1 as illustrated in Table 1. The error in an autocorrelation estimate typically has two main sources, noise and limited averaging over time. The autocorrelation is formally defined as an expectation value. When performing a measurement in real life, averaging is, however, limited to a few time instances, which results in an error. As may be seen in the example of FIG. 24, the standard deviation due to limited averaging is small when the autocorrelation is close to one and grows with the distance to one, i.e., it grows with (1−|Correlation|). In fact, as long as the autocorrelation is reasonably close to one, the standard deviation due to limited averaging grows roughly linearly with the distance of the autocorrelation to one, i.e., std≈α·(1−|Correlation|) for some constant α. As a consequence, reporting of log₁₀ (1−|Correlation|) with linear granularity allows for precise reporting of autocorrelation values close to one and less precise reporting of autocorrelation values further away from one. This saves signaling load without sacrificing the accuracy that is achievable at low noise for autocorrelation values close to one.

In some embodiment, the autocorrelation is reported as one of a set of predetermined values, where the granularity of the predetermined values is high close to the value one and goes down for values further away from one. This saves signaling load without sacrificing the good accuracy that is achievable at low noise for autocorrelation values close to one.

The autocorrelation is formally defined as an expectation value. When performing a measurement in real life, averaging is, however, limited to a few time instances, which results in an error. Here, the inherent variability of the non-averaged (one sample) autocorrelation for the TDL-A channel with 100 ns delay spread, bandwidth limited to 20 MHz is shown.

TABLE 1
Example Correlation and correlation offset values for reporting. corresponding to
a logarithmic step size of 1 dB ranging from −20 db to −3 dB for the correlation
offset.

| 10 · LOG10 (1 − \|Correlation\|) | Correlation_offset = 1 − \|Correlation\| | \|Correlation\| | Granularity | $\frac{Granularity}{1 - \vert Correlation \vert}$ |
|---|---|---|---|---|
| −20 | 0.010 | 0.990 | 0.0026 | 0.26 |
| −19 | 0.013 | 0.987 | 0.0033 | 0.26 |
| −18 | 0.016 | 0.984 | 0.0041 | 0.26 |
| −17 | 0.020 | 0.980 | 0.0052 | 0.26 |
| −16 | 0.025 | 0.975 | 0.0065 | 0.26 |
| −15 | 0.032 | 0.968 | 0.0082 | 0.26 |
| −14 | 0.040 | 0.960 | 0.010 | 0.26 |
| −13 | 0.050 | 0.950 | 0.013 | 0.26 |
| −12 | 0.063 | 0.937 | 0.016 | 0.26 |
| −11 | 0.079 | 0.921 | 0.021 | 0.26 |
| −10 | 0.100 | 0.900 | 0.026 | 0.26 |
| −9 | 0.126 | 0.874 | 0.033 | 0.26 |
| −8 | 0.158 | 0.842 | 0.041 | 0.26 |
| −7 | 0.200 | 0.800 | 0.052 | 0.26 |
| −6 | 0.251 | 0.749 | 0.065 | 0.26 |
| −5 | 0.316 | 0.684 | 0.082 | 0.26 |
| −4 | 0.398 | 0.602 | 0.103 | 0.26 |
| −3 | 0.501 | 0.499 | | |

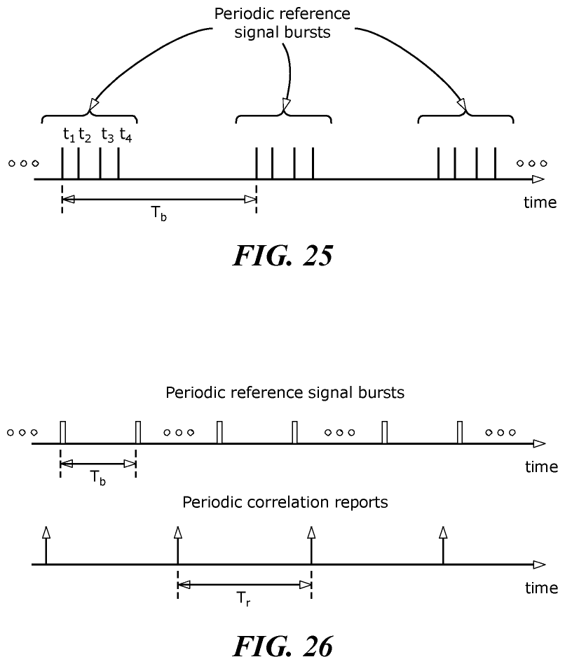

In some embodiments, the reference signals used for channel correlation measurement are periodic or semi-persistent as shown in FIG. 25, where a burst of four transmission instances of a reference signal is transmitted in each burst period T_{b}. In one scenario, intra-burst channel correlations are calculated and reported. In the example of FIG. 25, intra-burst correlations may include all or a subset of correlations calculated for {τᵢⱼ=tᵢ−tⱼ, i>j, i, j=1,2,3,4}. In another scenario, inter-burst correlations may be calculated and reported. The inter-burst correlations may include correlations calculated for {τₖ=kT_{b}, k=1, 2, . . . , K}, where K may be configured or predefined. In yet another scenario, both intra-burst and inter-burst correlations are calculated and reported. Both intra-burst and inter-burst correlations may be averaged over multiple burst periods, either by the WD 22 prior to reporting or by the network node 16 after receiving the reported correlations. Whether intra-burst or inter-burst correlations are configured may be based on factors such as the carrier frequency of the serving cell, e.g., 700 MHz or 4 GHz, and/or the serving cell types such as micro cell with small cell size in urban areas or macro cell with larger cell size serving suburban or rural areas. For a given WD 22 mobility speed, higher carrier frequency would have higher Doppler spread and thus lower channel correlation over a same time separation.

The correlation report may be periodic, semi-persistent, or aperiodic. An example of periodic correlation reporting is shown in FIG. 26, where the correlations are reported periodically every Tᵣ time period.

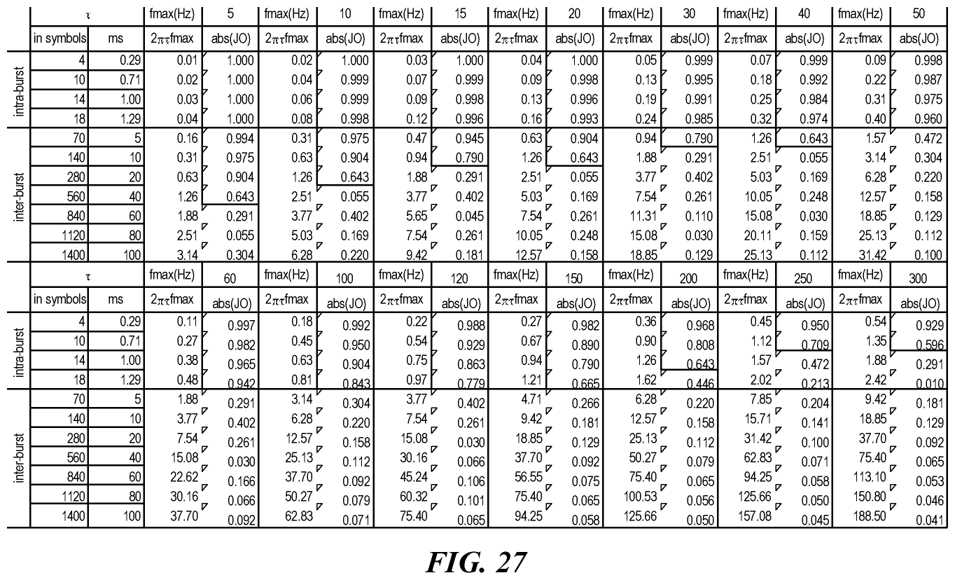

In some embodiments, when a threshold is used for reporting only correlations above the threshold, the threshold is only applied for correlations at certain delays. For example, in some embodiments, the threshold is applied only for inter-burst correlations and not applied for intra-burst correlations where 2πτfₘₐₓ≤2.4 for all possible Doppler frequencies and WD 22 speeds at the serving carrier frequency. An example is shown in FIG. 27, where absolute correlations given by the Jake's model for different values of maximum Doppler frequency, fₘₐₓ, and different values of delay τ are shown. TRS bursts are assumed with four intra-burst correlations calculated at delays 4,10, 14 and 18 symbols and inter-burst correlations at delays of 5 ms, and multiple 10 ms. It may be seen that for intra-burst correlations, 2πτfₘₐₓ≤2.4 for up to fₘₐₓ=300 Hz. Therefore, all intra-burst correlations may be reported.

On the other hand, if the threshold is applied to both intra-burst and inter-burst correlations, the correlations above the threshold are shaded in the example of FIG. 27. It may be seen that for fₘₐₓ≥50 Hz, only intra-burst correlations would be above the threshold and would be reported. Inter-burst correlations would be reported only for fₘₐₓ<50 Hz. In addition, for fₘₐₓ≥5 Hz, correlations at and below τ=40 ms may be calculated and reported. In this example, the maximum number of reported correlations would be eight, which occurs when the maximum Doppler frequency fₘₐₓ=5 Hz. The network node 16 may determine a coarse range of fₘₐₓ based on the actual number of reported correlations and finer range of fₘₐₓ may be further determined by curving fitting the reported correlations to an ideal correlation function such the Jake's model.

Report Average and/or Standard Variation Over N Measurements:

In some embodiments, the reported autocorrelation value of time interval τ is an average value over N multiple measurement occasions. The actual value of configurable N is dependent on at least one of the following parameters: carrier frequency range, subcarrier spacing, τ, TRS periodicity, TRS pattern and TRS reporting periodicity if TRS reporting is configured to be periodic or semipersistent. A set of numbers for averaging the autocorrelation over X symbols or Y ms may be predefined in a table or configured by RRC signaling. In addition to the average value, the WD 22 may also report the standard variation value over the N measurements.

### Activation and Triggering of TDCP Report:

The activation and deactivation of the TDCP report may be carried in RRC, MAC CE, or via DCI signaling. When using RRC, periodic TDCP reporting may be activated and/or deactivated; when using MAC CE, periodic or semipersistent TDCP reporting may be activated and/or deactivated; when using DCI, semipersistent report may be activated and/or deactivated, or aperiodic report may be triggered.

### Group-Based TDCP Reporting:

In some embodiments, as TRS is typically configured per cell for all the WDs within a cell, a DCI format may be defined to associate with a group of WDs for activating and/or deactivating aperiodic reporting or semi-persistent reporting. This group-based DCI is particularly beneficial if there is a use for new TRS burst pattern that results in large TRS overhead. A new radio network temporary identifier (RNTI), TDCP-RNTI may be configured to the WD 22 to be associated with the group-based TRS reception and TDCP reporting. The DCI contains an indication of TRS burst signaling including timing offset and TRS pattern, and an indication for PUSCH/PUCCH time and frequency resources for the WD 22 to send the TDCP report. The WD 22 may get configured with a WD-specific time offset and/or frequency offset in RRC or MAC CE to be associated with the information of resource allocation in the group-based DCI.

In some embodiments, the signaling from network node 16 to WD 22 is MAC CE signaling to update the first set of delay (τ) values.

In some embodiments, multiple delay sets may be configured in RRC with each delay set associated with a delay set identity index, here denoted as delaySetID.

In some embodiments, MAC CE or DCI field in DCI 0_1/0_2 is used to update the set of delay using the delaySetID.

In one example, the delaySetID may be indicated in a MAC CE such that the WD 22 updates the delay (τ) values an integer number slots after receiving the MAC CE. The integer number slots includes the time for the WD 22 to send an HARQ acknowledgement corresponding to the PDSCH carrying the MAC CE and the time for the network node 16 to receive/process the HARQ acknowledgement sent by the WD 22.

In another example, different delaySetID's are mapped to different codepoints of a field in DCI. When the WD 22 receives a DCI indicating a given codepoint in the field in DCI, the WD 22 updates the delay (τ) values to the delay values corresponding to the delaySetID. In some embodiments, a TRS configuration associated with an identity index, for example, NZP-CSI-RS-ResourceId, is paired with delaySetID and signaled to WD 22 in RRC signaling. In case of a WD 22 supporting multiple transmission/reception points (TRPs) and multiple TDCP measurements/reports, more than one pair of TRS-ID and delaySetID may be signaled to WD 22 in RRC. MAC CE or a field in DCI (e.g., DCI with formats 0_1 or 0_2) may be used to update which pair(s) of delaySetID. Also, the TRS-ID the WD 22 may use delays corresponding to the delaySetID and TRS-ID to measure and report the TDCP; and/or

In some embodiments, TRS configuration associated with an identity index, for example. NZP-CSI-RS-ResourceId, may be combined with a delaySetID and a threshold value and signaled to WD 22 in RRC signaling. In case of a WD 22 supporting multiple TRPs and multiple TDCP measurement/report, more than one combination of TRS-ID, delaySetID, and threshold value may be signaled to WD 22 in RRC. MAC CE or a field in DCI (e.g., DCI with formats 0_1 or 0_2). The WD 22 may use this information to update which combination(s) of delaySetID TRS-ID and threshold value the WD 22 may use to measure and report the TDCP.

In some embodiments, the correlation measurement is based on periodic reference signals (such as TRS) and the correlation report is semi-persistent with a periodicity in number of slots and a slot offset with respect to a slot in which an activation command/request for the semi-persistent report is received. The semi-persistent report may be de-activated at any time after activation. Multiple such semi-persistent reports may be configured for a WD 22 and one of them may be activated at any given time. Each of the multiple semi-persistent reports may be configured with a set of one or more delays for which channel correlations are to be measured and reported. Different set of delays may be configured for different semi-persistent reports. The network node 16 may request a WD 22 to measure and report channel correlations on a different set of delays by deactivating an ongoing semi-persistent report and activating another semi-persistent report with the desired set of delays. For example, one semi-persistent report may be configured with a set of delays within a TRS burst and another semi-persistent report is configured with a set of delays between TRS bursts.

Step 6: the WD 22 measures correlation values on the updated set of delay (τ) values in Step 5, and reports all or a subset of the correlation values to the network node 16.

In some embodiments, the network node 16 not only updates the delays associated with the measurement, but also modifies the configuration, triggering and/or transmission of the reference signals (RSs), e.g., TRSs, used for the correlation measurements according to the following example steps:
Step 1: The network node 16 signals an initial measurement configuration to the WD 22;
Step 2: The network node 16 signals an initial RS configuration to the WD 22;
Step 3: If the RS/RSs are aperiodic or semi-persistent (or semi-periodic), then the network node 16 signals to the WD 22 which of the configured RS/RSs that may be transmitted using DCI/MAC CE triggering;
Step 4: The network node 16 transmits the RS/RSs as configured and/or triggered;
Step 5: The WD 22 performs measurements based on the received RS/RSs;
Step 6: The WD 22 reports the measurements to the network node 16;
Step 7: Based on the measurement report, the network node 16 may signal a measurement reconfiguration to the WD 22;
Step 8: Based on the measurement report, the network node 16 may signal an RS reconfiguration to the WD 22;
Step 9: If the RS/RSs are aperiodic or semi-persistent (or semi-periodic) the network node 16 signals to the WD 22 which of the configured RS/RSs that may be transmitted using DCI/MAC CE triggering. The network node 16 choice of which RS/RSs that are triggered in this way is adopted based on the measurement report; and/or
Step 10: Go back to step 4 (i.e., perform Steps 4 to 9 iteratively).

In some embodiments neither aperiodic nor semi-persistent (or semi-periodic) RSs are used and step 3 is omitted.

In some embodiments, all modifications based on the measurement reports are made through the choice of what aperiodic/semi-persistent (or semi-periodic) RSs trigger with DCI/MAC CE and step 8 is omitted.

In some embodiments, step 7 omitted. Instead, measurement details are left for the WD 22 to decide and the WD 22 adopts the measurements and the measurement report based on the RS/RSs received.

In some embodiments, the WD 22 measures and reports the correlation for all delay (t) values that the received RS/RSs allow to be measured.

In some embodiments, the WD 22 measures the correlation for a number of delay (t) values that the received RS/RSs allow to be measured and reports some characteristics of the autocorrelation function based on the measurements.

In some embodiments, the WD 22 measures the correlation for a number of delay (t) values that the received reference signals allow to be measured and reports a subset of the measurements to the network node 1.

Step 8 (RS reconfiguration) may amount to a change of the periodicity T_TRS of the TRS to allow for inter burst correlation measurements with τ=n·T_TRS for integer values n.

Step 9 (DCI/MAC CE triggering of RS/RS(s)) may amount to triggering of a number of aperiodic TRSs separated in time to allow for correlation measurements for a set of delay (t) values.

Step 10 (DCI/MAC CE triggering of RS/RS(s)) may amount to triggering of one or more semi-persistent (or semi-periodic) TRS's with periodicity T_TRS of the TRS to allow for inter burst correlation measurements with delay τ=n·T_TRS for integer values n. If more than one semi-persistent (or semi-periodic) TRS is triggered the periodicity of the different TRSs may differ, allowing for more delay alternatives.

Some embodiments may include one or more of the following:

Embodiment A1. A network node configured to communicate with a wireless device (WD), the network node configured to, and/or comprising a radio interface and/or comprising processing circuitry configured to:
determine a set of delay values between tracking reference signals, TRS, over which to determine correlation values;
transmit the set of delay values to the WD; and
receive from the WD a report that includes a set of correlation values determined by the WD, the correlation values corresponding to the delay values.

Embodiment A2. The network node of Embodiment A1, wherein transmitting the delay values includes transmitting a bitmap indicating which of n autocorrelation values to be reported by the WD.

Embodiment A3. The network node of any of Embodiments A1 and A2, wherein transmitting the delay values includes transmitting positive integers a and b indicating a beginning time and ending time for the WD to determine correlation values.

Embodiment A4. The network node of any of Embodiments A1-A3, wherein transmitting the delay values includes transmitting a threshold to which the WD compares each correlation value to decide whether to include the correlation value in the report.

Embodiment B1. A method implemented in a network node configured to communicate with a wireless device, WD, the method comprising:
determining a set of delay values between tracking reference signals, TRS, over which to determine correlation values;
transmitting the set of delay values to the WD; and
receiving from the WD a report that includes a set of correlation values determined by the WD, the correlation values corresponding to the delay values.

Embodiment B2. The method of Embodiment B1, wherein transmitting the delay values includes transmitting a bitmap indicating which of n autocorrelation values to be reported by the WD.

Embodiment B3. The method of any of Embodiments B1 and B2, wherein transmitting the delay values includes transmitting positive integers a and b indicating a beginning time and ending time for the WD to determine correlation values.

Embodiment B4. The method of any of Embodiments B1-B3, wherein transmitting the delay values includes transmitting a threshold to which the WD compares each correlation value to decide whether to include the correlation value in the report.

Embodiment C1. A wireless device (WD) configured to communicate with a network node, the WD configured to, and/or comprising a radio interface and/or processing circuitry configured to:
receive from the network node a set of delay values between tracking reference signals, TRS, over which to determine correlation values;
determine a first set of correlation values corresponding to the set of delay values; and
transmit to the network node a second set of correlation values, the second set of correlation values being selected from the first set of correlation values.

Embodiment C2. The WD of Embodiment C1, wherein the second set of correlation values are correlation values of the first set of correlation values that are above a threshold.

Embodiment C3. The WD of Embodiment C2, wherein the threshold is based at least in part on a delay between TRS over which a correlation is determined.

Embodiment C4. The WD of any of Embodiments C1-C3, wherein the second set of correlation values are quantized values of the first set of correlation values.

Embodiment C5. The WD of any of Embodiments C1-C4, wherein a first transmitted correlation value is an absolute value and remaining transmitted correlation values in the second set of correlation values are differential values.

Embodiment C6. The WD of Embodiment C5, wherein the transmitted second set of correlation values are relative to a value of 1.

Embodiment D1. A method implemented in a wireless device (WD) configured to communicate with a network node, the method comprising:
receiving from the network node a set of delay values between tracking reference signals, TRS, over which to determine correlation values;
determining a first set of correlation values corresponding to the set of delay values; and
transmitting to the network node a second set of correlation values, the second set of correlation values being selected from the first set of correlation values.

Embodiment D2. The method of Embodiment D1, wherein the second set of correlation values are correlation values of the first set of correlation values that are above a threshold.

Embodiment D3. The method of Embodiment D2, wherein the threshold is based at least in part on a delay between TRS over which a correlation is determined.

Embodiment D4. The method of any of Embodiments D1-D3, wherein the second set of correlation values are quantized values of the first set of correlation values.

Embodiment D5. The method of any of Embodiments D1-D4, wherein a first transmitted correlation value is an absolute value and remaining transmitted correlation values in the second set of correlation values are differential values.

Embodiment D6. The method of Embodiment D5, wherein the transmitted second set of correlation values are relative to a value of 1.

Some embodiments may also include one or more of the following:

1A. Methods for reporting TDCP based on TRS comprising one or more of the following:
WD 22 receives signaling from the network node 16 of a set of delay values between TRS signals over which to measure or estimate correlation values;
WD 22 measures or estimates a first set of correlation values corresponding to the set of delay values;
WD 22 reports a second set of correlation values which may be all the values in the first set of correlation values or a subset of values in the first set of correlation values.

2A. The method of 1A, wherein the second set of correlation values are the correlation values from the first set of correlation values that are above a correlation threshold value.

3A. The method of 1A or 2A, wherein the second set of correlation values are quantized values of the first set of correlation values wherein the quantization is according to a predetermined set of correlation values.

4A. The method of any of 1A-3A, wherein the correlation threshold value is signaled to the WD 22 from the network node 16.

5A. The method of any of 1A-3A, wherein the correlation threshold is predefined in 3GPP specifications.

6A. The method of any of 1A-5A, wherein the reported second set of correlation values comprises a first correlation value is reported as an absolute value and the remaining correlation values in the reported second set of correlation values are differential correlation values relative to the first correlation value.

7A. The method of 6A wherein a first number of bits is used to quantize the first reported correlation value in the second set of correlation values and a second number, smaller than the first number, of bits is used to quantize the remaining correlation values in the reported second set of correlation values.

8A. The method of any of 1A-5A, wherein the all the correlation values in the second set are reported as absolute values.

9A. The method of 8A wherein the correlation values reported in the second set are relative to a value of 1.

10A. The method of any of 1A-9A, wherein the reported correlation values in logarithmic scale.

11A. The method of any of 1A-10A, wherein the correlation threshold is dependent on the delay values between TRS signals over which correlation is measured.

12A. The method of any of 1A-11A wherein reported correlation values before quantization are the real part of the measured or estimated correlation values.

13A. The method of any of 1A-12A wherein the reported correlation values before quantization are any one of the real part or the imaginary part of the measured or estimated correlation values.

14A. The method of any of 1A-13A, wherein the reported correlation values are normalized correlation values.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node configured to:
determine a set of delay values, each delay value of the set of delay values being a separation in time between reference signal symbols used to determine correlation values;
transmit the set of delay values to the WD; and
receive from the WD a report that includes a set of correlation values, the set of correlation values determined by the WD, the correlation values corresponding to the set of delay values.

2.-14. (canceled)

15. A method in a network node configured to communicate with a wireless device, WD, the method comprising:
determining a set of delay values, each delay value of the set of delay values being a separation in time between reference signal symbols used to determine correlation values;
transmitting the set of delay values to the WD; and
receiving from the WD a report that includes a set of correlation values, the set of correlation values determined by the WD, the correlation values corresponding to the set of delay values.

16.-28. (canceled)

29. A wireless device, WD, configured to communicate with a network node, the WD configured to:
receive from the network node a set of delay values, each delay value in the set of delay values being a separation in time between reference signal symbols used for determining correlation values;
receive from the network node a configuration to measure a first set of correlation values corresponding to the set of delay values;
measure the first set of correlation values corresponding to the set of delay values according to the configuration; and
transmit to the network node a second set of correlation values, the second set of correlation values including at least a subset of the first set of correlation values.

30. The WD of claim 29, wherein the set of delay values is received via Radio Resource Control, RRC, signaling.

31. The WD of claim 29, wherein the reference signal symbols are tracking reference signal, TRS, symbols.

32. (canceled)

33. The WD of claim 29, wherein the WD is configured to report a number of correlations the WD is configured to perform.

34. (canceled)

35. (canceled)

36. The WD of claim 29, wherein the second set of correlation values are quantized values of the first set of correlation values.

37. The WD of claim 29, wherein a first transmitted correlation value is an absolute value and remaining transmitted correlation values in the second set of correlation values are differential values.

38. The WD of claim 29, wherein the transmitted second set of correlation values are absolute values.

39. The WD of claim 29, wherein the transmitted second set of correlation values are relative to a value of 1.

40. The WD of claim 29, wherein the transmitted second set of correlation values are normalized correlation values.

41. A method in a wireless device, WD, configured to communicate with a network node, the method comprising:
receiving from the network node a set of delay values, each delay value in the set of delay values being a separation in time between reference signal symbols used for determining correlation values;
receiving from the network node a configuration to measure a first set of correlation values corresponding to the set of delay values;
measure the first set of correlation values corresponding to the set of delay values according to the configuration; and
transmitting to the network node a second set of correlation values, the second set of correlation values including at least a subset of the first set of correlation values.

42. The method of claim 41, wherein the set of delay values is received via Radio Resource Control, RRC, signaling.

43. The method of claim 41, wherein the reference signal symbols are tracking reference signal, TRS, symbols.

44. (canceled)

45. The method of claim 41, wherein the WD is configured to report a number of correlations the WD is configured to perform.

46. (canceled)

47. (canceled)

48. The method of claim 41, wherein the second set of correlation values are quantized values of the first set of correlation values.

49. The method of claim 41, wherein a first transmitted correlation value is an absolute value and remaining transmitted correlation values in the second set of correlation values are differential values.

50. The method of claim 41, wherein the transmitted second set of correlation values are absolute values.

51. The method of claim 41, wherein the transmitted second set of correlation values are relative to a value of 1.

52. The method of claim 41, wherein the transmitted second set of correlation values are normalized correlation values.
